(19) United States
(12) Patent Application Publication
(10) Pub. No.: US 2015/0134123 A1
(43) Pub. Date: May 14, 2015

(54) PREDICTIVE MONITORING AND CONTROL OF AN ENVIRONMENT USING CFD

(71) Applicant: CES Group, LLC, Eden Prairie, MN (US)

(72) Inventor: Izuh Obinelo, Nashua, NH (US)

(73) Assignee: CES Group, LLC, Eden Prairie, MN (US)

(21) Appl. No.: 14/540,918

(22) Filed: Nov. 13, 2014

Related U.S. Application Data
(60) Provisional application No. 61/904,228, filed on Nov. 14, 2013.

(51) Int. Cl. F24F 11/00; G05B 13/04

(52) U.S. Cl. CPC F24F 11/006; G05B 13/04
USPC 700/277; 700/276

(57) ABSTRACT

Computational fluid dynamics (CFD) can be used for modeling environment characteristics and for controlling instrumentation in sensitive environments, such as in an office building, datacenter, hospital, enclosed arena, airport, or other environment. In an example, power consumption characteristics from physical equipment assets in an environment can be used by a CFD circuit to improve accuracy of a CFD model. Information from a CFD model can be used to optimize efficiency of HVAC or other air-moving systems serving an environment. In an example, CFD analyses can be performed substantially in real-time when one or more inputs to a CFD model change, relative to a baseline value, by more than a specified threshold amount. An energy efficient and cost efficient response to a change in infrastructure of an environment can be identified based on a CFD model of the environment.

### CLAIM OF PRIORITY

This application claims the benefit of priority under 35 U.S.C. §119(e) of U.S. Provisional Patent Application Ser. No. 61/904,228, filed on Nov. 14, 2013, which is herein incorporated by reference in its entirety.

### BACKGROUND

Datacenters and other temperature-sensitive areas rely on moving or circulating large amounts of air to maintain the reliability of critical computing and communications equipment. Large office buildings, hospitals, and public facilities rely on an adequate supply of conditioned air to maintain an acceptable level of indoor air quality (IAQ) for occupants. Whether cooling critical equipment, or maintaining proper IAQ for the health of the occupants, a heating, ventilation, and air-conditioning (HVAC) infrastructure can be used to provide a right-sized volume of air at specified conditions to people and equipment. It can be costly and energy-intensive for an HVAC system to maintain a particular indoor environment, such as in a datacenter, a large commercial building, or in a large public facility such as a stadium, convention center, or other large venue.

In some examples, operation and maintenance of HVAC infrastructure can constitute 50% or more of a total cost of running a datacenter facility. Maintaining the high degree of reliability that can be required of such facilities can largely depend on an ability to avoid breakdowns in the cooling infrastructure. To reduce the likelihood of a breakdown, HVAC capacity can be provided at a greater level than is needed, or multiple redundancies can be designed into critical components of the system. This practice can drive up the capital cost and cost-of-ownership for such systems. It also places a burden on the public utility grid as large amounts of power can be required to run such systems. In turn, such high levels of power consumption can negatively impact the wider environment as more fuels are consumed to generate the required power.

### OVERVIEW

The present inventor has recognized, among other things, that a problem to be solved includes decreasing energy consumption of HVAC or other air-moving systems serving critical environments, such as datacenters. The present subject matter can help provide a solution to this problem, such as by using computational fluid dynamics (CFD) to generate information about an environment. Information about one or more environment variables can be sensed in real-time, compared to corresponding values in a CFD model of the environment, and one or more parameters of the physical environment can be updated or adjusted to improve energy efficiency, or to mitigate adverse events, such as a cooling unit failure.

In an example, a facility looking to “go green” and save costs in the process can use a comprehensive audit of installed HVAC systems and a rigorous analysis of actual need. Fortunately, for some facilities, such an audit and analysis can be effective, as some facilities were designed long ago without the benefit of rigorous or even cursory analysis, and some facilities or HVAC systems may have deteriorated overtime. More extensive analyses can be computationally intensive and expensive. A comprehensive and rigorous energy audit of critical or large infrastructures can involve analysis of an airflow distribution, as a large amount of energy can be involved in moving large quantities of air.

Airflow distribution analysis can be accomplished using various measurements. In an example, reliably identifying cost savings and mitigating inefficiencies can include using computational fluid dynamics (CFD). CFD, properly applied, can provide a comprehensive assessment of one or more of airflow, humidity, temperature, ergonomic comfort index, or other characteristic indication of a facility environment. CFD analyses can be used by designers or system operators to perform hypothetical analyses in order to optimize an HVAC or other air-handling system for a particular environment.

In an example, CFD analysis can be performed by a processor circuit configured to execute instructions from a non-transitory, tangible, processor-readable medium. Such CFD analysis can use a set of boundary conditions and/or initial conditions, such as can be measured, supplied by an operator, specified by a manufacturer, or otherwise provided as a system input. The CFD analysis can apply the boundary conditions or initial conditions over a given domain to solve the Navier-Stokes conservation equations for flow and heat transfer inside the domain.

In an example, solving the equations can include first breaking up the domain into an assembly of smaller cells, called elements or control volumes, and then applying the conservation equations on each cell individually, such as with considerations for any interaction and connectivity between the cells. The net result of this process can be to transform the conservation equations (e.g., non-linear continuum equations that can be difficult to resolve numerically) into a discrete equation system that can then be fed into a linear matrix solver (e.g., using the same or different processor circuit) to calculate a value of the conserved quantities inside each cell of the domain. FIG. 5 of the present document illustrates this process generally.

Even with the linearization provided by the discretization process, it can be difficult to resolve the Navier-Stokes equations inside a domain that is more complex than a simply connected volume. An impediment in the numerical discretization process can include an unmanageably large number of cells—with correspondingly large computing time and resources—to resolve the conservation equations inside of the domain for even simple volumes. Some algorithms can get around this impediment by using a reasonable number of cells within the domain, and implementing a set of closure equations, called constitutive equations, at the domain surfaces. These constitutive equations can include phenomenological relationships derived through experimentation and empirical observation.

For example, air (or any fluid) can slow down to a zero velocity at a structural surface, and there can be a thin layer next to a physical surface where there can be a sharp gradient of velocity as it increases from a zero velocity value to a “free stream” value. There can be a direct relationship between this velocity gradient and a shear stress caused by the fluid flow, and constitutive equations of this relationship are generally known. Other constitutive equations can be used to relate this shear stress to the rate of heat transfer across the surface. In an example, some CFD algorithms can take advantage of these constitutive equations, as well as empirical correlations, to offer practical solutions of the Navier-Stokes equations in complex systems. A manner of implementation or quality of closure equations can differentiate algorithms in terms of accuracy or ability to handle different types of fluid flow phenomena. Boundary conditions can be used to determine a specific solution for a given domain, and can be normally absorbed into the solution process via one or more closure equations.

In an example, given a CFD algorithm and sufficiently accurate usage information, one or more boundary conditions can be responsible for an accuracy of the distributions predicted by the CFD algorithm. Inaccuracy of boundary conditions can be an Achilles' heel of using traditional CFD codes to compute airflow and temperature distribution within a facility. In a large facility, such as having hundreds or thousands of pieces of environmentally-sensitive or environmentally-altering equipment, boundary conditions (such as equipment heat dissipations and flow rates, and supply flow rates) can be unavailable, and simple nameplate information from equipment assets is often inadequate. Typical values can be assumed for certain classes of equipment and, in these circumstances, CFD analysis can be used to provide qualitative comparisons of different designs or equipment populations during a design or major retrofit phase. This kind of analysis can be crude in a dynamic environment, such as in a facility where boundary conditions can continuously change, or in a facility whose design, population, or layout can change.

Building management systems can implement some form of supervisory control and data acquisition framework. Such a framework can include one or more environment sensors distributed throughout a facility, and the sensor units can be used to monitor the environment. Acquired data can be used to provide supervisory control of an air conditioning plant or other prime mover installed around the facility.

In an example, a supervisory control and data acquisition framework can be characterized by good record keeping and an open architecture. An advantage of implementing a supervisory control and data acquisition framework over legacy and analog feedback systems (e.g., including thermostat and air-conditioner units) can include an ability to maintain historical records of equipment performance data. In some installations, data from one or more sensors in a facility can be gathered and stored in a central database, such as can be accessible from anywhere within the building management infrastructure. Third-party applications can access and use the data for other purposes, such as for generating periodic system reports. In an example, computerized maintenance management programs can use historical analysis of equipment performance data to generate equipment maintenance requests.

In a supervisory control and data acquisition framework, archived data or live data from one or more sensors can be accessed by third-party applications. For example, the instrumentation or control devices in the system can be configured to support one or more industry-standard open device communication protocols. Some protocols include MODBUS, BACNET, and SNMP. By using interfaces to these protocols, a third party application can access any of the devices in the supervisory control and data acquisition network and can request live data.

In an example, a maintenance program can incorporate means for mining archived or live sensor data, such as continuously or periodically, to provide a historical analysis of individual equipment performance. This analysis, or continuous commissioning, can be used to detect equipment deterioration, or to identify inefficiency, such as can develop in a system over time. With continuous commissioning, it can be possible to detect a recent or impending equipment or system failure and to take appropriate preventive actions.

To determine an efficiency of a specified piece of equipment or process, critical performance metrics can be identified or defined. Then a means of determining a numerical value for each performance metric can be put in place. Environmental performance of a critical facility can be defined in terms of a status or health of each piece of equipment in the facility, as well as a status or health of one or more critical pieces of equipment in the larger system. For a reasonably large facility, this can require a correspondingly large amount of instrumentation. Instrumentation can be expensive in initial costs, and also in ongoing costs associated with maintenance of various sensors or calibration requirements.

In a large datacenter with hundreds or even thousands of racks of equipment assets, monitoring instrumentation, such as to monitor an operating environment around computing equipment, can be prohibitively expensive. In some examples, up to three sensors per rack can be used in order to obtain an accurate measure of a temperature distribution at an intake of each of the racks. For example, part of a rack exhaust or nearby equipment exhaust air can recirculate to an intake of a rack, and a temperature distribution at an intake can vary widely. Hence, multiple sensors can be recommended for a single rack of equipment assets. In an example, temperature data provided by one or more sensors can be critical for maintaining a level of reliability required or desired for a facility, and a cost of implementing or maintaining a sensor network can be prohibitive for modest to large size facilities.

In an example, a control volume of a discretized domain can correspond to a virtual sensor location. Each virtual sensor can be configured to measure at least one of a velocity, temperature, pressure, or relative humidity characteristic. Such an instrumentation network can be very powerful and pervasive, as every point in the space throughout the facility can be monitored. The network can be low cost, such as compared to a cost of implementing an equivalent system using physical sensors.

A challenge in devising such a system can include providing accurate measurements. CFD computations can be inaccurate, not necessarily because of the CFD technology itself, but often because of inaccuracies in inputs or boundary conditions, as well as approximations made in a modeling geometry. In an example, such errors can be attributed to an experience level of the CFD user or to an availability of equipment data. An expert system, such as capable of self-correction, can use a CFD circuit to perform CFD computations over time. The CFD computations can be calibrated in-situ to provide environment “measurements” that can be comparable in accuracy to physical sensors.

In an example, a CFD circuit can use measured data from a variety of sensor units or self-reporting equipment assets for self-calibration to improve accuracy of calculated distributions. An actual equipment power consumption, which can vary in time, can be measured and used as an input into a CFD calculation. Environmental monitoring data from one or more sensors can be used to calibrate CFD predictions.

In an example, a CFD circuit can include a supervisory control and data acquisition framework configured to measure power consumption characteristics of any equipment assets in an environment, such as can be measured at a branch circuit or at an outlet power strip, such as additionally or alternatively to a temperature, velocity, humidity, or other environment characteristic measured by dedicated sensor units. In an example installation, a CFD circuit can use temperature information that is measured using physical sensor units and can use temperature information that is computed in a CFD model at the same or different locations. Temperature differences between measured and computed values can be used to update or calibrate the CFD model.

Run-time conditions can often be different from conditions at a time of installation. For example, a volumetric flow rate through an equipment asset can be measured with a wind tunnel in a laboratory, such as without accounting for any obstructions around the intake or exhaust vents. However, obstructions can exist in an actual installation, such as including due to cables or neighboring equipment or rack doors. In such cases, an actual airflow rate through the equipment asset can be different from a value measured under the idealized conditions of the wind tunnel. In general, a mass flow rate through a piece of equipment can vary over the life of the asset, such as due to filter blockage from contaminants or other factors.

For each physical sensor location, such as after any insignificant sensitivity coefficients and errors associated with measured or known equipment values are zeroed out, a CFD circuit can be configured to correct one or more unknown quantities based on a difference between measured and calculated temperatures. To make the corrections, the CFD circuit can assume that an error in the two temperature values can arise from weighted contributions from all influential pieces of equipment whose input values are not exactly known.

In a network of multiple physical sensors at different locations in an environment, a given asset can influence more than one physical sensor location. In some cases, it can be likely that all of the sensors within a particular area of influence can behave similarly with respect to an operating point of the equipment. A prioritization scheme can be based on values of sensitivity coefficients corresponding to the various sensor units, such as to determine which HVAC unit or other air-handling system can be most efficiently and effectively used to influence a particular location.

In an example, a CFD circuit can operate continuously with a supervisory control and data acquisition framework to update sensor data and calculate updated solution fields using the measured data. In an example, a supervisory control and data acquisition framework can operate on a faster clock than it takes to achieve convergence of measured and calculated data in the CFD subsystem. In some examples, the environment in a datacenter or other facility can be relatively steady or only slowly changing, and therefore the CFD circuit can keep up with real variations in the environment.

A quality or accuracy of a CFD model generated by the CFD circuit can depend in part on sensor unit accuracy, and on a placement of sensors used for the calibration. The sensor placement can be strategic, and can depend at least in part on a facility layout. Accuracy can be improved by using additional sensor units or power measurements, however, relatively few sensors can be used if they are strategically placed (e.g., determined through trial and error given a particular environment layout).

In an example, only major power dissipating equipment is monitored for power consumption. Such power measurements can be made at a higher, branch circuit level. In an example, not all sensor measurements need to be permanent or continuous; periodic measurements, such as with hand-held instruments, can be additionally or alternatively used.

In an example, a CFD circuit can be used for live-monitoring or control of HVAC or other air-handling systems, such as to maximize energy efficiency in an environment. In an example, the CFD circuit can be applied for trouble-shooting or continuous commissioning of HVAC or other air-handling systems. In an example, the CFD circuit can be used to provide live measurement information about airborne contaminants or constituents within an environment.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example of a cooling topology for a datacenter environment.

FIG. 2 illustrates generally an example of a system that can be used to apply CFD-based analysis to dynamically control an environment.

FIG. 3 illustrates generally an example of a cooling topology for a datacenter environment.

FIGS. 4A and 4B illustrate generally examples of smart zones in a datacenter environment.

FIG. 5 illustrates generally a schematic example of a discrete model of an environment and several inputs to the model.

FIG. 6 illustrates generally an example of an energy profile of an equipment asset.

FIG. 7 illustrates generally an example of a method that can include generating a CFD model.

FIG. 8 illustrates generally an example of a method that can include using zone information with a CFD model.

FIG. 9 illustrates generally an example of a method that can include validating information about an environment.

FIG. 10 illustrates generally an example of a method that can include updating an operating characteristic of a climate control device based on a zone of influence.

FIG. 11 illustrates generally an example of a method that can include updating a boundary condition based on a temperature calculation.

FIG. 12 illustrates generally an example of a method that can include using multiple postulated environment scenarios.

FIG. 13 illustrates generally an example of a method that can include updating a CFD.

FIG. 14 illustrates generally an example of work flow distributions in an environment controller based on CFD.

FIG. 15 illustrates generally an example that can include a CFD model update.

FIG. 16 illustrates generally an example of a method that can include identifying hot spots in one or more smart zones.

FIG. 17 illustrates generally an example that can include optimizing a cooling infrastructure using CFD analyses.

### DETAILED DESCRIPTION

This detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventors also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, method, or process that includes elements in addition to those listed after such a term in a claim are still deemed to fall within the scope of that claim. Moreover, in the appended claims, the terms “first,” “second,” and “third,” etc. are used merely as labels, and are not intended to impose numerical requirements on their objects. In the event of inconsistent usages between this document and any documents so incorporated by reference, the usage in this document controls.

Disclosed herein are systems and methods for using computational fluid dynamics (CFD) to optimize control of an enclosed environment. The enclosed environment can be served by one or more fluid moving devices. As used herein, the term fluid refers to a substance that is able to flow freely within the environment, such as air. A fluid moving device can be a device configured to directly physically move air in an environment, such as using a fan, or to indirectly move air in the environment, such as by creating a pressure differential due to, e.g., radiant heating. In an example, a fluid moving device includes a portion of a heating, ventilation, and air-conditioning (HVAC) system, such as an air-conditioner unit.

The systems and methods described herein can be used to update a fluid flow distribution and/or energy consumption characteristic (e.g., of a fluid moving device or an energy-consuming asset) in an enclosed environment. The fluid flow distribution can be considered to be substantially optimized when an amount of energy consumed by one or more fluid moving devices is minimized while maintaining a specified target temperature, humidity, or other environment condition. In an example that includes a datacenter, a substantially optimized fluid flow distribution can be attained when components such as servers, networking equipment, power supplies, and other hardware devices in the environment receive sufficient cooling fluid flow to maintain a temperature within a predefined range, while also minimizing an amount of energy required by HVAC or other systems to supply the sufficient cooling fluid flow to the various components.

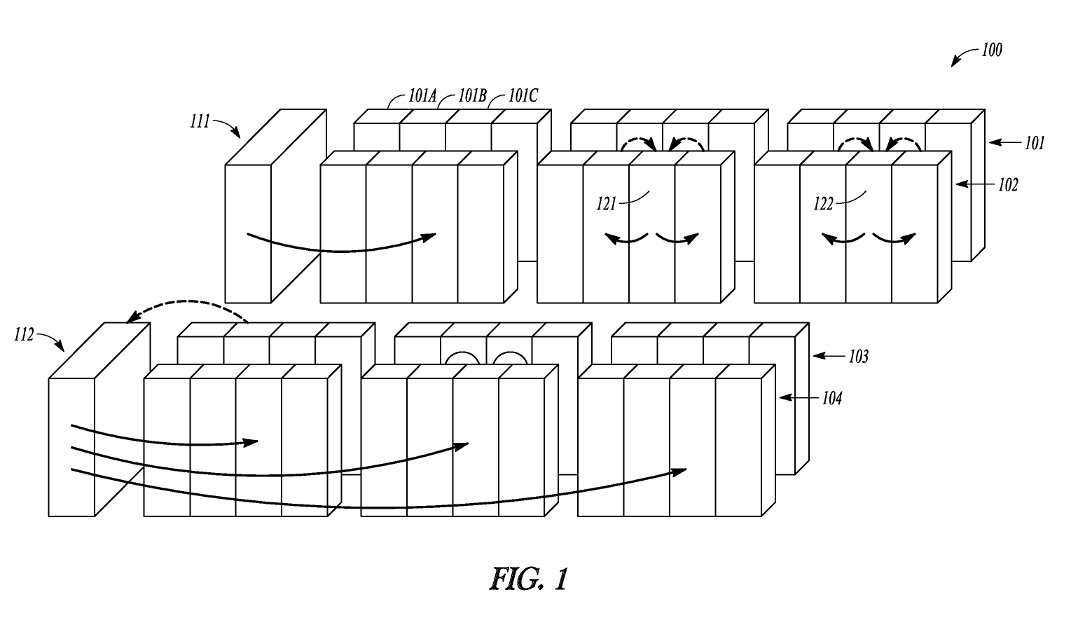

FIG. 1 illustrates generally an example of a cooling topology for a datacenter environment 100. The datacenter environment 100 includes multiple rows of racks 101, 102, 103, and 104, of equipment assets, such as including computer processor units and storage servers. The racks of equipment assets can be arranged back-to-back to form alternating hot and cold aisles. In the example of FIG. 1, a first row of racks 101 includes a first rack 101A, a second rack 101B, a third track 101C, and so on.

A datacenter can include a closed loop cooling system whereby cooling air is supplied from an output of one or more computer room air conditioner (CRAC) units to the air intake of one or more equipment racks. Hot air from the equipment racks can be exhausted from the one or more equipment racks and returned to an input of the one or more air conditioner units, such as to be re-conditioned and supplied again at the output of the one or more CRAC units.

Air conditioner units can be located inside or outside of an enclosed datacenter room. In the example of FIG. 1, first and second CRAC units 111 and 112 are provided at the periphery of the datacenter environment 100. The first CRAC unit 111 is configured to direct cooling air primarily toward first and second rows 101 and 102 of equipment assets, and the second CRAC unit 112 is configured to direct cooling air primarily toward third and fourth rows 103 and 104 of equipment assets.

An air conditioner unit can be located in-line with an equipment rack row. In an example, a CRAC unit can include a small chiller, such as approximately the same size as an equipment rack unit, and can be located alongside one or more racks. Such CRAC units are sometimes referred to as in-row cooler (IRC) units positioned adjacent to racks of equipment assets. FIG. 1 illustrates first and second IRC units 121 and 122. In the example of FIG. 1, cooling airflows from CRAC or IRC units are represented by arrows with solid-line tails, and return airflows to the CRAC or IRC units are represented by arrows with dashed-line tails.

In other examples, air conditioner units can be located outside of the datacenter environment 100. Cooled air can be supplied to the datacenter environment 100 through one or more ducts and supply registers, diffusers, or a plenum (raised floor). Hot air can be returned via returned via designated return ducts and registers. In some datacenter environments that include a raised floor, chilled air from one or more CRAC units is flooded into a plenum below the raised floor, and the chilled air flows into the datacenter environment by way of perforated tiles or grates.

Regardless of the layout or topology of a datacenter environment, a design objective of a datacenter cooling system includes maintaining environment areas at specified acceptable levels of temperature and humidity. Temperature and humidity specifications can be set by a system operator, or can be pre-set by a control system. Some datacenters have hundreds or thousands of equipment assets that are sensitive to temperature and/or humidity, and the equipment assets can be distributed over hundreds or thousands of square feet, such as on one or more different levels.

To accommodate large scale datacenter environments, a common practice is to over-design cooling infrastructure to ensure hot spots (areas where a temperature, such as a server intake temperature, is greater than a specified temperature) are avoided. A consequence of over-designing a facility can be energy waste, as more cooling energy than is needed can be consumed in an effort to avoid hot spots. Opportunities exist to reduce operating costs by improving cooling efficiency. In some examples, optimizing an air flow distribution alone can conserve a significant amount of energy.

One technique for avoiding hot spots includes using temperature sensors positioned strategically in an environment, such as at intakes of each equipment asset in an environment, to monitor environment conditions and provide information to a system controller. Such a configuration can be untenable in environments with hundreds or thousands of equipment assets, or nodes, to monitor. Instead of monitoring at every intake, some systems suggest measuring at every other equipment rack. Even in these examples, the system can be expensive and difficult to manage, while achieving only 50% coverage. In some examples, equipment assets can include integrated temperature sensors configured to provide information about a unit temperature (e.g., at a central processing unit (CPU) or graphics processing unit (GPU)).

In an example, a datacenter is cooled using multiple air conditioner units under the control of a central or distributed control system. To effectively cool an environment, the control system can be configured to determine a portion of the environment that each air conditioner unit serves, or exerts influence over, and to responsively activate one or more units based on actual conditions in the respective portions of the environment. The portions of the environment, or zones, affected or served by multiple air conditioner units can overlap. When multiple zones overlap, a changed setting on one air conditioner unit can result in competing systems unless the units are coordinated using a central system. For example, one CRAC unit may be humidifying a first zone in response to a measured environment characteristic in the first zone, while a second CRAC unit is dehumidifying a second zone in response to a measured environment characteristic in the second zone. Further complicating the control scenario, what happens in one equipment asset can impact other equipment racks. For example, raising a temperature in a specific zone can result in some racks in other zones operating out of specification or overheating.

Another example of an environment scenario that can be difficult to manage includes an equipment asset or a portion of an equipment asset that is newly installed or removed from service. Such changes can impact a temperature of other equipment assets in the vicinity. To compensate for such changes, the control system can be aware of the interactions in order to coordinate a proper response. Awareness can be achieved by analyzing an airflow distribution throughout the environment. One way to perform such an analysis is using computational fluid dynamics (CFD) to model or simulate the conditions of the environment. A system using substantially real-time CFD-based analysis can provide a platform for dynamic control and optimization of energy use in an environment, such as a datacenter. In some examples, control decisions can be made on a measured value of one or more environment conditions, such as informed by a virtual simulation of one or more proposed system changes.

CFD analysis of a domain can include receiving a set of boundary conditions and initial conditions, and applying those conditions over a given geometrical domain to solve the Navier-Stokes conservation equations for fluid flow and heat transfer inside the domain. In some examples, a domain is first divided into smaller cells, called elements or control volumes, and then the conservation equations are applied on each cell individually, mindful of the interaction and connectivity between the cells. The net result of this process, called discretization, is to transform the conservation equations, which are non-linear continuum equations that can be difficult to resolve numerically, into a discrete equation system that can be processed using a linear matrix solver to calculate values of conserved quantities inside each cell of the domain.

Even with the linearization provided by the discretization process, it can still be difficult to resolve the Navier-Stokes equations inside any domain more complex than a simply connected volume. An impediment in the numerical discretization process is that most practical systems would require an infinitely large number of cells, and therefore computing time and resources, to resolve the conservation equations inside the domain and all the way to the boundaries. Some CFD algorithms can get around this impediment by using a reasonable number of cells within the domain and implementing a set of closure equations, called constitutive equations, at the domain surfaces. The constitutive equations can represent phenomenological relationships derived through experimentation or empirical observation and measurement. Practical CFD algorithms take advantage of these constitutive equations, as well as empirical correlations, to offer practical solutions of the Navier-Stokes equations in complex systems. Boundary conditions, which can be used to determine a specific solution for a given domain, can be absorbed into the solution process via the closure equations. That is, known or measured values of quantities at the boundaries can be substituted into the constitutive equations and empirical correlations to fill out the right-hand-side of the discrete equation system.

Given a properly implemented CFD algorithm and properly experienced usage, the boundary conditions can ultimately determine the accuracy of the distributions predicted by the CFD algorithm. Inaccuracies of boundary conditions, however, can hinder use of CFD algorithms to compute accurate airflow and temperature distribution within an environment. For example, in a large facility with hundreds or thousands of equipment assets, most boundary conditions, including heat dissipation and flow rate characteristics, may not be readily available. Typical values can be assumed for some classes of equipment, and in these circumstances CFD analysis can be used to provide qualitative comparisons of different designs or equipment populations. Such analysis can be insufficient in a dynamic environment, such as a datacenter, where boundary conditions are continuously changing and the design and population of the facility itself are continually evolving.

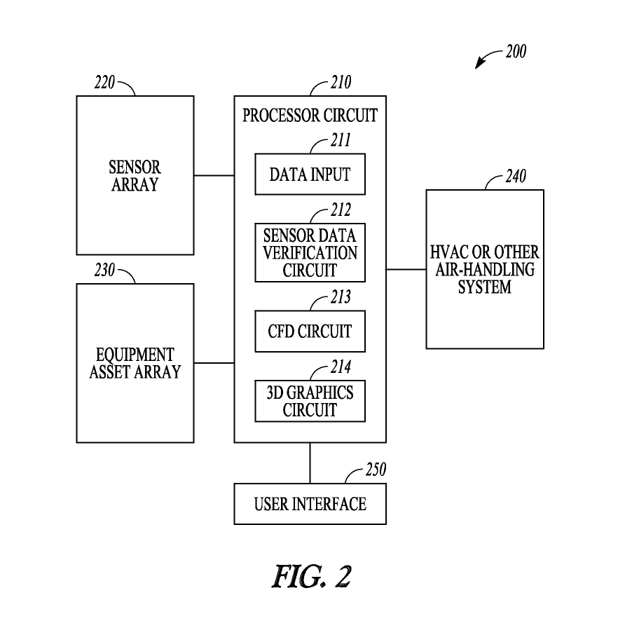

FIG. 2 illustrates generally an example of a system 200 that can be used to apply CFD-based analysis to dynamically control an environment. The system 200 includes an equipment asset array 230, a sensor array 220, a processor circuit 210, an HVAC or other air-handling system 240, and a user interface 250. In the example of FIG. 2, the sensor array 220 is communicatively coupled with the processor circuit 210 such that information from one or more sensors in the sensor array 220 can provide information to, or receive information from, the processor circuit 210. The equipment asset array 230 can be communicatively coupled with the processor circuit 210 such that information from one or more equipment assets can provide information to, or receive information from, the processor circuit 210. For example, the equipment asset array 230 can provide power usage or other environment characteristic information (e.g., using one or more sensors integrated with equipment assets in the asset array) to the processor circuit 210. In some examples, the processor circuit 210 can be used to distribute processing load, or to provide sleep/wake or process execution timing instructions to the equipment assets in the array 230.

The processor circuit 210 can include multiple different modules that can be centrally located or can be distributed across different computing environments. In an example, the processor circuit 210 includes a data input 211, a sensor data verification circuit, a CFD circuit 213, and a 3D graphics circuit 214. The data input 211 can be configured to receive a data signal from one or more of the sensor units or equipment assets in the sensor array 220 and the equipment asset array 230. The sensor data verification circuit 212 can be configured to determine whether information received from individual ones of the sensor units in the sensor array 220 are reporting valid data. The CFD circuit 213 can be configured to process the information received from the sensor array 220, the equipment asset array 230, the HVAC or other air-handling system 240, and the user interface 250 to generate a real-time CFD model of the environment. In an example, the CFD circuit 213 can be configured to generate one or more CFD models of the environment in response to information from the user interface 250, or in response to an anomaly identified automatically using the processor circuit 210.

Some of the examples described herein, including the processor circuit 210 and the various arrays and air-handling systems, can include respective circuits, logic, or a number of components, modules, processors, or other mechanisms. As described herein, a circuit or module can include a processing layer or platform. Modules may constitute either software modules (e.g., code embodied (1) on a non-transitory machine-readable medium or (2) in a transmission signal) or hardware-implemented modules. A hardware-implemented module can include a tangible unit capable of performing certain operations and may be configured or arranged in a certain manner. In example embodiments, one or more computer systems (e.g., a standalone, target, or server computer system) or one or more processors may be configured by software (e.g., an application or application portion) as a hardware-implemented module that operates to perform operations as described herein.

In some examples, a hardware-implemented module can be implemented mechanically or electronically. For example, a hardware-implemented module can include dedicated circuitry or logic that is permanently configured (e.g., as a special-purpose processor, such as a field programmable gate array (FPGA) or an application-specific integrated circuit (ASIC)) to perform certain operations. A hardware-implemented module can include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

As used herein, the term “hardware-implemented module” should be understood to encompass a tangible entity that can be physically constructed, permanently configured (e.g., hardwired) or temporarily or transitorily configured (e.g., programmed) to operate in a certain manner and/or to perform certain operations or transactions described herein. Considering embodiments in which hardware-implemented modules are temporarily configured (e.g., programmed), each of the hardware-implemented modules need not be configured or instantiated at any one instance in time. For example, where a hardware-implemented module comprises a general-purpose processor configured using software, the general-purpose processor may be configured as respective different hardware-implemented modules at different times. For example, a general-purpose processor may be configured to instantiate functions of different components of the integration platform at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules can initiate communications with input or output devices, and can operate on a resource (e.g., a collection of information).

The various operations of example methods described herein may be performed, at least partially, by one or more processor circuits that are temporarily configured (e.g., by software) or permanently configured to perform the relevant operations. Whether temporarily or permanently configured, such processor circuits may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processor circuits or processor-implemented modules. Some operations may be distributed among the one or more processor circuits, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors can support performance of the relevant operations in a cloud computing environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Referring again to FIG. 2, the sensor array 220 can include one or more sensor units that are physically distributed in an environment to be monitored. The sensor units can be coupled with rack units, with equipment assets, or with a building infrastructure (e.g., at wall surfaces, at vertical or horizontal structural support beams, etc.). A sensor in the sensor array 220 can be configured to receive environment characteristic information and, in response, generate an analog or digital data signal that can be transmitted to the processor circuit 210 or to another destination. In an example, a sensor includes a thermal imaging camera that can receive temperature (relative or absolute) information. In an example, a sensor includes a moisture sensor such as configured to generate a signal indicative of a relative humidity or other moisture characteristic. In an example, a sensor includes a chemical sensor configured to identify a chemical composition or concentration and to generate a corresponding signal indicative of the identified composition or concentration.

The equipment asset array 230 can include one or more power-consuming or heat-generating assets in an environment to be monitored. In an example, an asset includes a computer server, computer processor, or other unit, such as can be rack mounted. The HVAC or other air-handling system 240 can include a fluid mover configured to physically influence or move air in an environment, such as using one or more fans, ducts, or vents. In an example, the HVAC or other air-handling system 240 includes an air conditioner or heater unit. The HVAC or other air-handling system 240 can include a humidifier, dehumidifier, air filter, or other device configured to influence a characteristic of ambient air in an environment to be monitored.

The user interface 250 can include a user input device and a display device. The display device can include a monitor that is configured to receive 3D graphic information from the 3D graphics circuit 214. The display can render a pictorial representation of an environment to be monitored, such as including representations of one or more equipment assets, HVAC or other air-handling devices, and structural features such as walls or other boundaries that can influence airflow in the environment.

Operated together, the portions of the system 200 can be used to apply CFD analysis with measurement and control hardware to dynamically monitor or control a sensitive environment, such as including a portion of a datacenter or other critical facility. The system 200 can be applied to optimize one or more energy consumption characteristics of the environment while ensuring a thermal integrity of computing hardware contained in the environment. In an example, real-time CFD analyses can be performed to dynamically optimize cooling infrastructure of critical facilities.

Systems and methods described herein can be used to achieve and maintain environmental requirements (e.g., temperature and humidity) to sustain critical equipment assets in an environment, while minimizing energy consumption by all components of the cooling infrastructure and, where possible, the constituents of the environment. Various examples described herein can be used for measuring environment parameters (e.g., using the sensor array 220), quantifying and evaluating the cooling performance (e.g., using the processor circuit 210 to apply mathematical solvers and solution algorithms), and optimizing control of the cooling infrastructure equipment (e.g., using control algorithms at the CFD circuit 213).

Systems and methods described herein can be used to provide short-term or long-term planning platforms for datacenter or other facility operators. Various system components can be used to generate models or postulated operating scenarios based on changing equipment populations in or physical structure of an environment. In an example, the systems and methods described herein can be used to test effects of postulated changes and then present the resulting performance information to a user via the user interface 250. In an example, presenting the resulting performance information can include displaying one or more of energy consumption information or calculated efficiency characteristic information. A datacenter or other facility operator can use these tools to evaluate the merits of a proposed change to an environment before implementation of the change.

Systems and methods described herein can provide a platform for maintenance and continuous commissioning of an environment, such as a datacenter. In an example, a historical record of an environment's operational metrics can be maintained, and various algorithms can be used to process the operational metrics and present information about the metrics in terms of individual equipment asset performance characteristics. A datacenter or facility operator can use the historical performance information in a computerized and automated maintenance program for all equipment assets and cooling infrastructure equipment.

Systems and methods described herein can further provide a disaster recovery mechanism for disasters or failures involving HVAC or other air-handling systems serving an environment. With the aid of the knowledge base built and maintained by the system, such as in terms of sensitivity parameters and constitutive relationships between the prime movers of the cooling infrastructure and the resulting environmental performance, the system can determine appropriate mitigating actions such as in the event of a malfunction or unavailability of a CRAC unit.

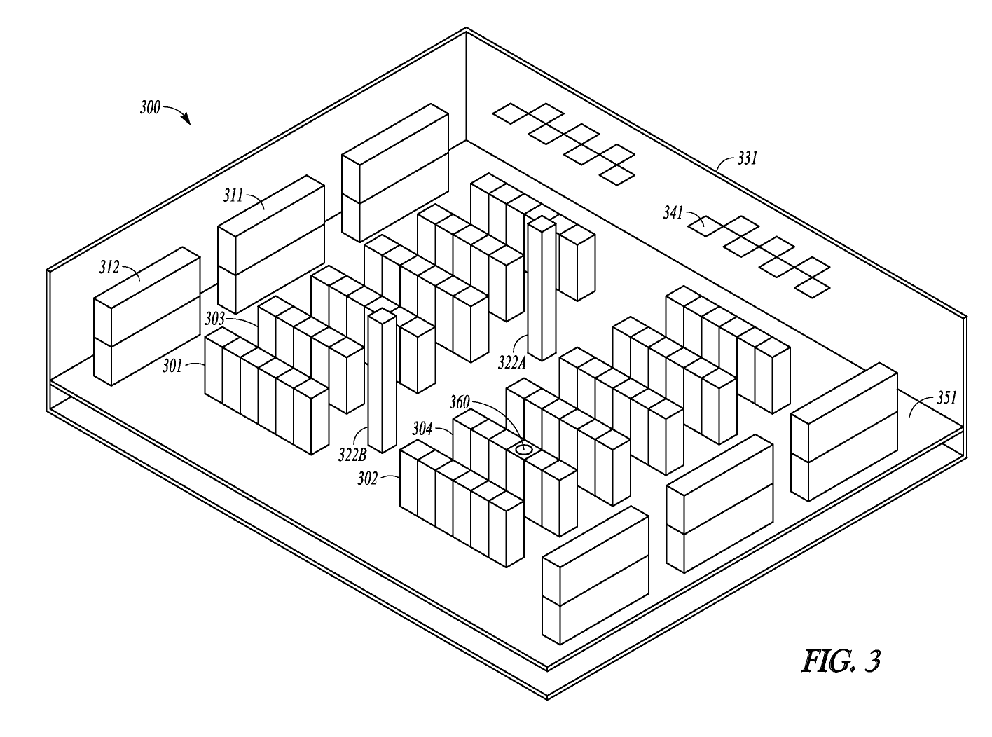

In an example, the processor circuit 210 includes a software-implemented module that can receive or import information about an environment or building structure, information about electrical or mechanical systems serving the environment, information about constituents of the environment, including computing or other energy-consuming assets, and information received from measurement or sensing systems that are configured to measure or sense environment characteristic information, such as temperature, humidity, or particulate concentration. The information can be stored and maintained in a database accessible to the other software-implemented modules that can be accessed or processed using the processor circuit 210. With this information, the processor circuit 210 can build a three-dimensional model of the environment, such as shown in the example model 300 of FIG. 3.

The example model 300 includes first and second equipment assets 301 and 302, such as including first and second racks of server equipment. The example model 300 includes multiple CRAC units 311 and 312 arranged in the same room as the first and second equipment assets 301 and 302. The room further includes walls 331 and structural support pillars 322A and 322B, such as can be arranged in the example model 300 to correspond to an actual physical environment that the model represents. The example model 300 further includes representations for ceiling vent tiles 341 and a raised floor 351.

The processor circuit 210 can include a mesh builder module that is configured to subdivide an environment model into discrete control volumes that can be used for analysis, such as for real-time CFD analysis. In the example of FIG. 3, the mesh builder can be configured to receive information about the example model 300 and compute or determine the discrete control volumes corresponding to the space bounded by, for example, the walls 331. The discrete control volumes can be used as a mesh for CFD analysis.

The example model 300 can be built in Virtual Reality Modeling Language (VRML), such as for desktop rendering, or in X3D, such as for internet browser-based rendering, among other ways. Within the model, each physical asset can be built as a system of indexedFaceSet nodes or objects of a graphical description language. For example, each indexedFaceSet node can represent a surface of each equipment asset, or parts thereof. A ViewPoint node can be placed at locations corresponding to sensor units within the model. The ViewPoint node can be aimed in the direction of a corresponding camera or sensor with a same FieldOfValue in order to precisely and accurately map pixel values from an image to corresponding surfaces of the indexedFaceSet, and thereby to specific cells in a CFD mesh.

In an example, multiple different levels of discrete control volumes can be generated, including a baseline CFD mesh, sensor zones, and smart zones. Fewer or additional levels of discretization can optionally be used. In an example, the baseline CFD mesh is the finest of the three levels of discretization. The Navier-Stokes conservation equations (see, e.g., Equations 1-3) can be discretized and solved on the control volumes at the baseline CFD mesh level, such as using the CFD circuit 213. In an example, a baseline CFD model and a real-time CFD model can be solved using the same control volumes of the baseline CFD mesh.

Generating the baseline CFD mesh can include virtually subdividing the example model 300 into multiple control volumes (e.g., hundreds or thousands of virtual control volume units), such as having similar or different shapes. Surfaces of all equipment assets within the example model 300 can be subdivided into corresponding discrete control surfaces. In a CFD model, mass, momentum, energy, particle concentrations, or other quantities can be conserved within each control volume (and thereby the domain as a whole), while various boundary conditions can be applied on the control surfaces, corresponding to each equation solved.

In an example, another level of a discrete control volume for use by the CFD circuit 213 includes a sensor zone. A sensor zone includes a virtual area in a model around one or more of the sensor units in the sensor array 220. Depending on a type of sensor unit used and the prevailing velocity profile and temperature distribution at or near the sensor unit, a sensor zone can include a single cell of a baseline CFD mesh (e.g., corresponding to a discrete mesh unit corresponding to a sensor unit location), or can include a combination of multiple cells at or near a particular sensor unit. In some examples, a sensor zone includes an area corresponding to a relatively large section of a model, such as an entire enclosed equipment asset aisle, such as where there is minimal temperature variation.

In an example, the CFD circuit 213 computes a central tendency, such as an average value, of a sensed quantity (e.g., sensed using one or more sensor units in the sensor array 220) within the sensor zone. The sensed value or central tendency can be compared to a corresponding CFD-computed value. In an example, the central tendency includes a numeric average, a mass-weighted average, a volume-weighted average, or a harmonic average.

In an example, another level of a discrete control volume for use by the CFD circuit 213 includes a smart zone. A smart zone includes a virtual area in a model that is affected by, or responsive to, changes generated by a particular unit or portion of the HVAC or other air-handling system 240. For example, a model environment can be subdivided into zones of influence corresponding to each unit in the HVAC or other air-handling system 240 to generate as many smart zones as there are units in the HVAC or other air-handling system 240. The CFD circuit 213 can be configured to determine one or more smart zones automatically, for example, based on a sensitivity of cooled equipment assets to variations in the performance of each portion of the HVAC or other air-handling system 240. One or more smart zones can overlap, such as to reflect the overlapping influence and interaction of two or more air movers that are in fluid communication, such as due to being located in a common portion of an environment.

A smart zone can correspond to a setting of a unit in the HVAC or other air-handling system 240. In an example, a first unit includes air-conditioning and humidifying capabilities. A first smart zone can correspond to an area of influence in an environment when the first unit is performing an air-conditioning function, and a second smart zone can correspond to an area of influence in an environment when the first unit is performing a humidifying function.

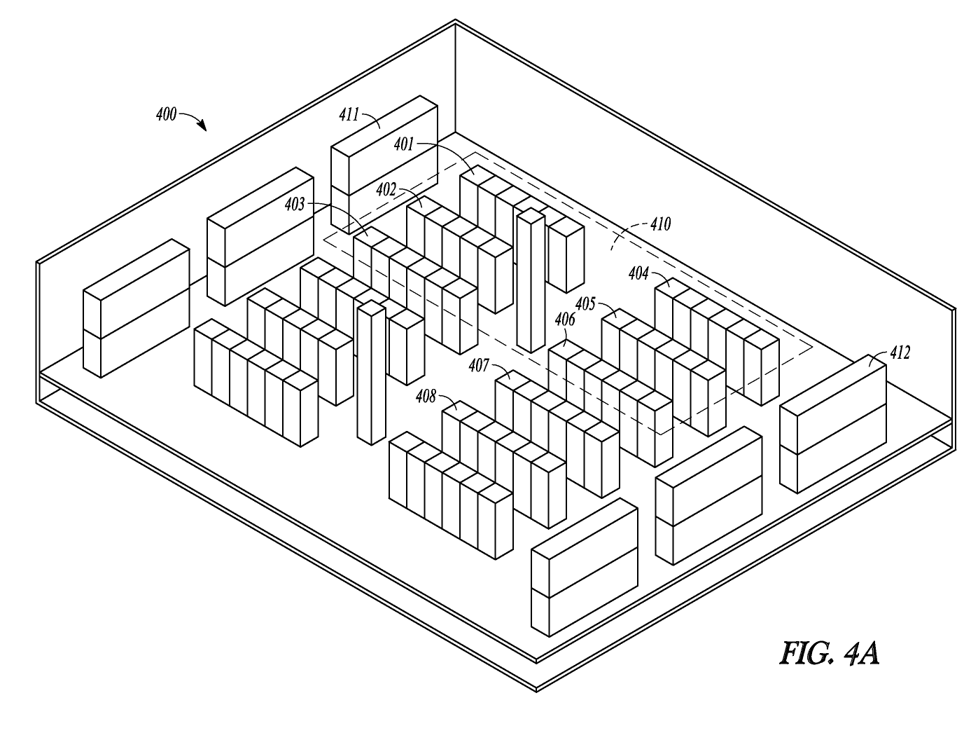

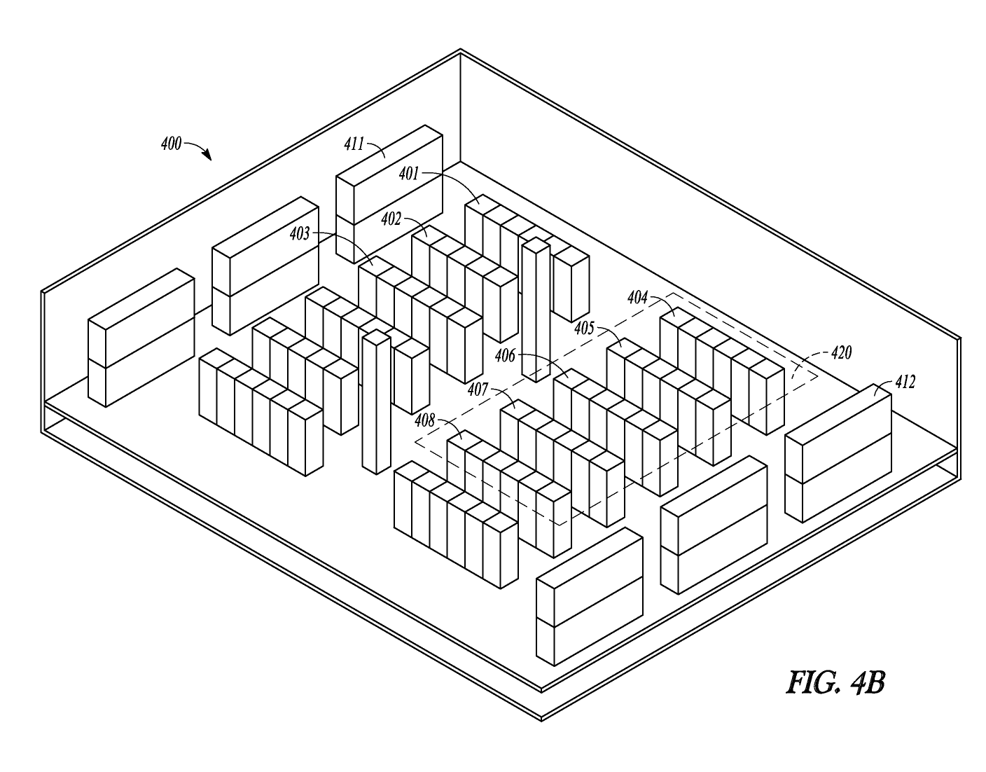

FIGS. 4A and 4B illustrate generally examples of first and second smart zones 410 and 420 in an environment 400. The environment 400 includes, among other things, multiple equipment assets 401-408, and first and second CRAC units 411 and 412. In the example of FIG. 4A, the first smart zone 410 corresponds to the first CRAC unit 411, and the first smart zone 410 further corresponds primarily to the equipment assets 401-406. That is, the first CRAC unit 411 can be considered to have a zone of influence where it can effectively adjust an environment characteristic, and that zone of influence includes at least the equipment assets 401-406. In the example of FIG. 4B, the second smart zone 420 corresponds to the second CRAC unit 412, and the second smart zone 420 further corresponds primarily to the equipment assets 404-408. That is, the second CRAC unit 412 can be considered to have a zone of influence where it can effectively adjust an environment characteristic, and that zone of influence includes at least the equipment assets 404-408. Because the smart zones 410 and 420 overlap in part, such as at equipment assets 404-406, these assets may receive additional cooling when the first and second CRAC units 411 and 412 are operated concurrently.

The CFD circuit 213 can include a numerical processing engine that is configured to perform continuous, real-time fluid dynamic analysis of air flow, and associated heat and moisture transport, within an environment. In an example, the CFD circuit 213 includes a baseline CFD model and solver, and tools and methods for updating boundary conditions inside the CFD model and solver, such as substantially in real-time based on sensed information from the environment. In an example, a CFD model generated by the CFD circuit 213 can be continuously updated by comparing real-time predictions, based on the CFD model, with actual measured values, such as received using the sensor array 220. Thus, a CFD model that is processed by the CFD circuit can be checked or validated substantially in real-time using sensor-based feedback information from an environment to which the CFD model itself corresponds. In an example, a model update can be calculated when some specified number of environment variables change by greater than a specified threshold amount.

Using information about a three-dimensional space, the CFD circuit 213 can be applied to solve a system of conservation equations for mass (Equation 1), momentum (Equation 2), and energy (Equation 3).

$$\begin{matrix}\frac{\partial ρ}{\partial t} + \frac{\partial }{\partial {x}_{j}} ( ρ {u}_{j} ) = 0 & ( Equation 1 ) \\ \frac{\partial }{\partial t} ( ρ {u}_{i} ) + \frac{\partial }{\partial {x}_{j}} ( ρ {u}_{j} {u}_{i} ) = \frac{\partial P}{\partial {x}_{i}} - \frac{\partial {τ}_{ij}}{\partial {x}_{j}} + {S}_{ui} & ( Equation 2 ) \\ \frac{\partial }{\partial t} ( ρ {c}_{v} T ) + \frac{\partial }{\partial {x}_{j}} ( ρ {u}_{j} {c}_{p} T ) = \frac{\partial }{\partial {x}_{j}} ( k \frac{\partial T}{\partial {x}_{j}} ) & ( Equation 3 )\end{matrix}$$

In Equations 1-3, ρ is a density of the fluid to be modeled, uᵢ is a velocity in the xᵢ-coordinate direction, P is a static pressure, τᵢⱼ is a viscous stress tensor, T is the fluid temperature, cᵥ and cₚ are the specific heat capacity at constant volume and at constant pressure, respectively, and Sᵤᵢ represents additional momentum source terms. Equations 1-3 can be discretized using the baseline CFD mesh described above. Applied together, the mass, momentum, and energy equations can be applied using information about each equipment asset in an environment to influence the boundary conditions of a CFD model. In some examples, an equipment asset can be represented by at least two characteristic equations corresponding respectively to airflow and energy characteristic profiles of the equipment.

The CFD circuit 213 can use boundary conditions and closure equations to solve the conservation equations. A boundary condition can be based on, among other things, environment characteristic information (e.g., temperature, humidity, barometric pressure, particulate concentration, or other information about the environment), or measured, power consumption or power usage characteristic information corresponding to one or more equipment assets in the environment. In an example, a boundary condition can be based on an operating characteristic of one or more air movers in the HVAC or other air-handling system 240, such as fan speed information.

In an example, the CFD circuit 213 can use characteristic equations to model an air-flow or other thermodynamic behavior of one or more components of the HVAC or other air-handling system 240, for example, of a CRAC unit, an IRC unit, a fan wall, a chiller, an economizer system, a diffuser, a flow grid, or other heat exchanger located within the environment. In some examples, the performance characteristics of the one or more components of the HVAC or other air-handling system 240 can be substantially real-time performance values obtained directly from the equipment itself, such as using a SCADA interface.

In an example, the CFD circuit 213 can model an equipment asset using pressure and volume information. An equipment asset with a fan can be modeled as a net static pressure increase across the intake and exhaust vents of the asset, and an asset without a fan can be modeled as a volumetric or planar pressure loss, such as depending on how deep the equipment happens to be in the net flow direction. Each equipment asset can have one or more intake vents, one or more exhaust vents, and one or more fans to drive airflow through the equipment. The net volumetric airflow through the equipment can be denoted as V, and ΔP can denote a net static pressure increase or decrease across the asset. That is, airflow through an equipment asset can be modeled as shown in Equation 4.

$$Δ P ∝ f ( \frac{ρ {V}^{2}}{2} ) \qquad ( Equation 4 )$$

For equipment with air movers, the functional dependence f from Equation 4 can be based on an actual fan curve if available (such as can be derated by an aggregate flow resistance through the equipment). For passive elements, f can be a minor pressure loss coefficient for planar elements, such as ceiling registers or diffusers, or f can be a pressure loss coefficient per unit length for deeper profiles such as heat exchangers. In an example, the CFD circuit 213 can use a net static pressure drop or gain imposed as a boundary condition on exhaust faces of equipment assets, such as according to Equation 5.

$$Δ {P}_{o} = ( k + Δ k ) ( \frac{{ρ ( V + Δ V )}^{2}}{2} ) \qquad ( Equation 5 )$$

In Equation 5, ΔV on can represent a real-time adjustment to a volumetric airflow to reflect an actual fan speed, and Δk can represent a real-time adjustment on a pressure drop coefficient, and can change over time for any given equipment asset. Adjustments to the pressure drop coefficient can be representative of an actual change, such as a change in a permeability of an air filter (e.g., due to dust accumulation or replacement with a new filter), or a change in a diffuser or flow grille serving the environment. In an example, an adjustment to a pressure drop coefficient can be a result of correcting an initial value or assumption made during the model tuning process to match a postulated model with an actual measurement.

Equation 5 illustrates an example of a portion of an algorithm that can be used to update a CFD model, such as using the CFD circuit 213, to reflect actual operating conditions of the environment, including of the equipment asset array 230 and the HVAC or other air-handling system 240. In an example, the CFD circuit 213 can initially solve and store a baseline CFD model. In some examples, multiple different baseline CFD models can be solved and stored. When a fan in the HVAC or other air-handling system 240 is ramped up or down, or when a flow grille is adjusted, or when some other change is made to the environment, changes can be made to the boundary conditions using the CFD circuit 213 to bring the CFD model in line with actual measured conditions.

In an example, a non-linear dependence of a pressure drop or airflow can imply that a CFD model may not drift too far from the baseline, or that prevailing conditions cannot differ too drastically from the initial baseline. For instance, a large swing in fan speed (e.g., from off to on) or a large adjustment in a flow characteristic of a grille (e.g., from partially open to completely closed), can invalidate the baseline CFD model. The CFD circuit 213 can accommodate such changes by applying a different configuration corresponding to a different baseline. For example, different baseline CFD models can be provided.

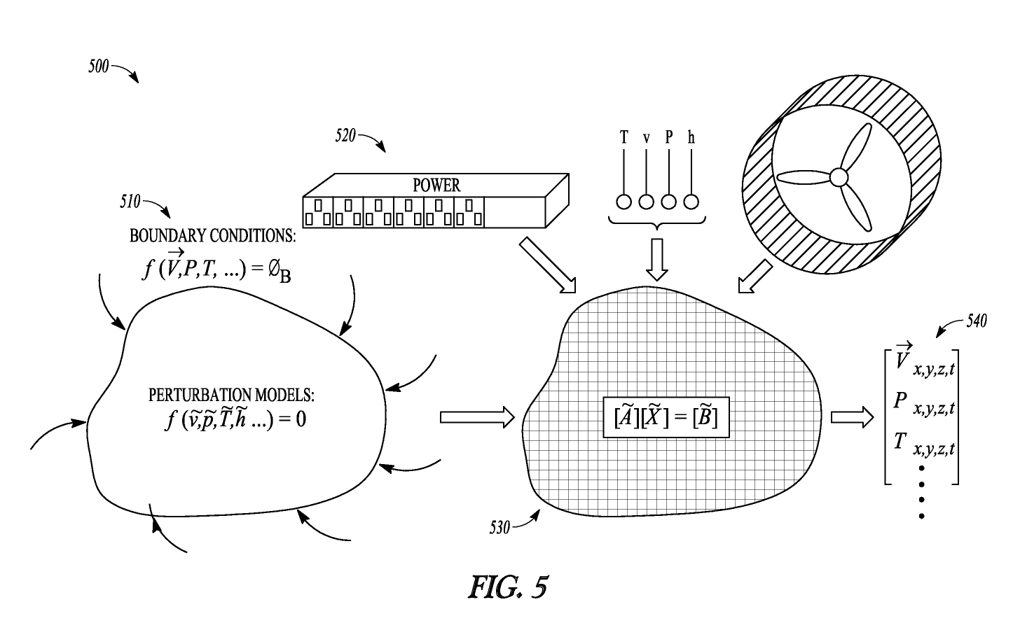

FIG. 5 illustrates generally an example 500 that includes using the CFD circuit 213. At 510, perturbation models can be built from the phenomenological (constitutive) relationships and boundary conditions that comprise a baseline CFD model of an environment. Using a perturbation model, such as instead of generating an entirely new CFD model, CFD analysis can be carried out substantially in real time because it can be computationally less intensive than generating a new model. In an example, a perturbation model can be automatically built in situ when a system is deployed to manage a given facility, and the perturbation model can adjust to reflect prevailing equipment asset configurations or operational characteristics.

At 520, information from one or more sensors or equipment assets (e.g., in the sensor array 220 or the equipment asset array 230) can be provided to the CFD circuit 213. Among other information, the one or more sensors or equipment assets can be configured to provide information about power consumption, temperature, volume, pressure, humidity, or volumetric flow rate to the CFD circuit 213. The CFD circuit 213 can be used to discretize an environment and, in the discrete domain 530, can calculate various distributions 540 of flow, temperature, pressure, or other quantities within the domain.

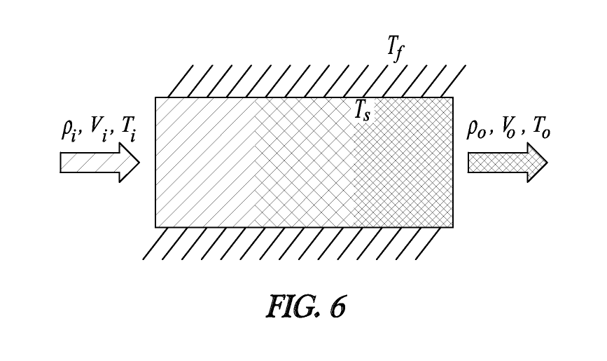

FIG. 6 illustrates generally an example of an energy profile of an equipment asset. The energy profile can be considered to be a balance between an enthalpy inflow and outflow through the vents of the equipment asset. In an example, a convective heat transfer between all surfaces of the equipment and the surrounding fluid, and the heat generated or removed by the equipment, can be represented by Equation 6.

Q=Σ(ρvcₚT)ₒ−Σ(ρvcₚT)ᵢ−∫_{A}h(Tₛ−T_{f}) (Equation 6)

Equipment assets can be modeled as a “black box”, that is, with disregard for internal components and internal airflow characteristics. In an example, Equation 6 can be applied as a boundary condition on an enthalpy characteristic of air entering an environment from the exhaust vents of all of the equipment assets in the environment. That is, air exiting an equipment asset can be considered collectively and can be considered to have a uniform temperature. In an example, an exception to this treatment can include a temperature of a server rack in a datacenter, such as can be “U-averaged” in some modeling examples (as further described below).

In an example, a convective heat transfer from a surface of an equipment asset to a surrounding fluid can be relatively small compared to a bulk heat transport across multiple equipment asset vents. In this example, Equation 6 can be simplified by dropping the last term, which represents a convective heat transfer. Thus, the boundary condition on the exhaust vent of a given equipment asset can be represented as in Equation 7.

$${T}_{o} = \frac{1}{\dot{m} {c}_{{p}_{o}}} [ Q - \sum {( ρ {Vc}_{p} T )}_{i} ] \qquad ( Equation 7 )$$

In an example that includes a CFD model, a boundary condition can be represented in terms of a deviation from a value generated using a baseline CFD model, such as in Equation 8. In this manner, a heat dissipation change can be applied to current or recently-monitored conditions to quickly and continuously update a CFD model, such as using the CFD circuit 213. The linear dependence between heat dissipation and temperature distribution with a given flow distribution implies that changes in heat dissipation, in air-conditioner temperature settings, and in ambient temperature, can be adequately accounted for, for example, as long as the underlying flow field and equipment configuration do not change significantly.

$${T}_{o} = \frac{1}{\dot{m} {c}_{{p}_{o}}} [ ( Q + Δ Q ) - \sum {( ρ {Vc}_{p} T )}_{i} ] \qquad ( Equation 8 )$$

A validated thermodynamic model of an environment, such as can be continuously updated using real-time feedback information from the sensor array 220 or the equipment asset array 230, can be used for monitoring, controlling, or optimizing the HVAC or other air-handling system 240 serving the environment. In an example, the model can be used to minimize energy consumption and increase system efficiency.

In an example, each control volume of the virtual discrete domain in a CFD model can correspond to a virtual sensor location. Each virtual sensor in this domain can measure a velocity, temperature, relative humidity, static air pressure, or other characteristic, such as using a CFD model generated by the CFD circuit 213. Within this framework, every point in the modeled environment can be used as a sensor location, such as to compute a performance metric or for use in system control.

Referring again to FIG. 3, the model environment can include the first CRAC unit 311 and multiple equipment assets 301-304. A temperature sensor 360 can be used to monitor an intake of the fourth equipment asset 304. A temperature Tᵢ measured by the temperature sensor 360 can depend on the heat dissipations of the fourth equipment asset 304, as well as the respective heat dissipation characteristics of neighboring equipment assets and the heat removal capability of the CRAC units serving the environment, such as according to Equation 9.

Tᵢ=f(Q₁,Q₂,Q₃,Q₄,Q₅,\dot{m}₁,\dot{m}₂,\dot{m}₃,\dot{m}₄,\dot{m}₅) (Equation 9)

In Equation 9, Qⱼ is the heat dissipation of equipment j, and \dot{m}ⱼ is the mass flow rate of air through equipment j. Any cooling unit can be assigned a negative heat dissipation to indicate heat removal. Equation 9 can be alternatively written in terms of enthalpy flow through each equipment asset, as in Equation 10.

Tᵢ=f(H₁,H₂,H₃,H₄,H₅) (Equation 10)

In Equation 10, Hⱼ=\dot{m}ⱼCₚTⱼ is the enthalpy flow, out of equipment j, referenced to a given temperature such as an ambient or CRAC unit temperature setting. In an example, the measured temperature Tᵢ can depend in part on a temperature characteristic external to the model environment, such as including an outside temperature, a solar heat load on one or more of the environment walls, or other factors. In an example, such other temperature characteristics can be included in a CRAC unit heat removal capability characteristic.

Given the functional dependence in Equation 9, a small perturbation of Tᵢ can be caused by a change in an operating point of one or more of the equipment assets, such as described in Equation 11.

$$α {T}_{i} = \frac{\partial {T}_{i}}{\partial {Q}_{1}} Δ {Q}_{1} + \frac{\partial {T}_{i}}{\partial {Q}_{2}} Δ {Q}_{2} + \frac{\partial {T}_{i}}{\partial {Q}_{3}} Δ {Q}_{3} + \frac{\partial {T}_{i}}{\partial {Q}_{4}} Δ {Q}_{4} + \frac{\partial {T}_{i}}{\partial {Q}_{5}} Δ {Q}_{5} + \frac{\partial {T}_{i}}{\partial {\dot{m}}_{1}} Δ {\dot{m}}_{1} + \frac{\partial {T}_{i}}{\partial {\dot{m}}_{2}} Δ {\dot{m}}_{2} + \frac{\partial {T}_{i}}{\partial {\dot{m}}_{3}} Δ {\dot{m}}_{3} + \frac{\partial {T}_{i}}{\partial {\dot{m}}_{4}} Δ {\dot{m}}_{4} + \frac{\partial {T}_{i}}{\partial {\dot{m}}_{5}} Δ {\dot{m}}_{5} \qquad ( Equation 11 )$$

In Equation 11, the coefficient

$${f}_{ij} = \frac{\partial {T}_{i}}{\partial {Q}_{j}}$$

corresponds to a sensitivity of a temperature to a heat dissipation of equipment j, and coefficient

$${g}_{ij} = \frac{\partial {T}_{i}}{\partial {\dot{m}}_{j}}$$

corresponds to a sensitivity of a temperature to an air flow rate of equipment j. When a parameter for heat dissipation or airflow rate changes, such as for each equipment asset in a baseline model, the CFD circuit 213 can compute and store an updated sensitivity parameter, such as for each temperature and humidity sensor in the model environment. Generally, a perturbation in the temperature of a sensor i may be expressed as shown in Equation 12. A temperature difference between measured and computed temperatures is given in Equation 13.

ΔTᵢ=Σⱼ₌₁ⁿfᵢⱼΔQⱼ+Σⱼ₌₁ⁿgᵢⱼΔ\dot{m}ⱼ (Equation 12)

ΔTᵢ=Tₘ−T_{c}=Σⱼ₌₁ⁿfᵢⱼΔQⱼ+Σⱼ₌₁ⁿgᵢⱼΔ\dot{m}ᵢⱼ (Equation 13)

In Equation 13, Tₘ and T_{c} are the measured and computed temperatures, respectively. The variables ΔQⱼ and Δ\dot{m}ⱼ correspond to changes in the heat dissipation and air flow rate of equipment j.

In some examples, there can be relatively few sensor units, that is, temperature measurement locations, compared to the number of equipment assets in the environment. In this case, the system of equations corresponding to Equation 15 can be undetermined (i.e., with more unknown quantities than number of equations). However, in practice, a temperature at any given sensor location can be dictated by multiple primary or dominant parameters, such as including a temperature, fan speed, or humidity setting of the HVAC or other air-handling systems serving the environment. In an example, a computed sensitivity parameter can be used by the CFD circuit 213 to diagnose a cause of a measured anomaly at a given sensor. For example, when an over-temperature condition or hot spot is detected, the CFD circuit 213 can identify one or more of the available CRAC units to mitigate the over-temperature condition. When an under-temperature condition is detected, such as due to over-cooling, the CFD circuit 213 can identify which of the active CRAC units to switch off or dial down in order to conserve energy and cooling costs.

In an example, the CFD circuit 213 can run continuously and monitor the sensor array 220 and the equipment asset array 230 for changes in one or more of sensor measurements, power consumption, control settings, equipment status, or manual operator input, among other things. A CFD model generated by the CFD circuit 213 can be continuously updated to reflect observed changes. The model update can be carried out in a number of steps as outlined below.

First, the CFD circuit 213 can be configured to poll one or more sensor units in the sensor array 220, one or more equipment assets in the equipment asset array 230, or one or more units in the HVAC or other air-handling system 240. In response, the CFD circuit 213 can receive one or more of temperature information, relative humidity information, power consumption information, fan speed, or pressure information.

Second, the CFD circuit 213 can be configured to determine whether to use information from all available inputs or to use a subset of the available information. Under some conditions, one or more sensor units can be excluded from the model analysis, such as depending on whether information from a particular sensor unit, equipment asset, or air-handling unit, is valid. Data validation can lead to detection of abnormal events and appropriate remedial measures can be taken in a timely manner. In an example, a data validation step can identify when a sensor is out of calibration, or can identify data noise, such as when wireless sensors are used. In an example, the data validation step can be used to determine when a unit or asset is relocated, or when a battery is depleted. In an example, a system operator can manually identify one more sensor units, equipment assets, or air-handling units to exclude from the CFD update process, such as using the user interface 250.

In an example, the CFD circuit 213 can include an analytic module that can automatically exclude information from a unit or asset if an anomaly is detected. In an example, the CFD circuit 213 can include a memory component that stores historical information for each sensor unit, equipment asset, and air-handling unit in the environment. At each update cycle, or less frequently, the received information for a particular unit or asset can be compared with a historical trend corresponding to the same unit or asset. Any sensed information that differs from the historical trend, such as by more than a specified threshold amount over a specified period (e.g., five degrees in a ten minute span), can be flagged as suspect for further analysis. In an example, a user-specified number of standard deviations can be used as the threshold amount. Any flagged information can be excluded from a current CFD model update cycle. At subsequent update cycles, the suspect information can be re-introduced to the analysis, such as if the information returns to within the specified limits, or if the information remains consistent at the new value for some specified duration. A system operator can be automatically notified of all flagged sensed information.

After validating the information from one or more sensor units, equipment assets, or air-handling units, boundary conditions and characteristic equations in the CFD model can be updated using the validated information. For example, a measured power characteristic for a particular equipment asset can be used to update a corresponding boundary condition to be applied by the CFD circuit 213 in a model update cycle. In an example, fan speed information can be used to proportionally adjust velocity boundary conditions, or static pressure information can be used to proportionally adjust a velocity boundary condition.

Individual supply temperatures of each air-handling unit can also be input to the CFD circuit 213 as a boundary condition. In an example, measured temperature characteristics at the equipment assets can also be used to adjust corresponding boundary conditions where sensitivity coefficients are known.

Next, the CFD circuit 213 can calculate one or more fictitious heat sources or heat sinks to facilitate the CFD analysis. The fictitious heat sources or heat sinks can represent a difference between an actual, measured environment characteristic value and a value predicted by the model. For example, where Equation 13 results in more unknowns than equations for any reasonable number of physical sensors, it can be impractical to use Equation 13 to update a CFD model. To overcome this limitation, an inverse scalar transport algorithm can be implemented by the processor circuit 210. The inverse scalar transport algorithm can be applied to scalar quantities, such as heat and humidity, among others. Using inverse scalar transport, the fictitious heat sources and sinks can be calculated at one or more physical sensor unit locations, such as on the equipment assets, according to Equation 14.

ΔQ′=ρVΔT′=ρV(Tₛ−T_{cfd}) (Equation 14)

In Equation 14, Tₛ is a measured temperature and T_{cfd} is a current (e.g., mass-weighted) average temperature in the CFD solver, such as within the sensor zone. If a CFD solution could be entirely accurate, the inverse scalar transport units, or fictitious heat sources and heat sinks, would be identically zero. If the inverse scalar transport units are not identically zero, then the CFD circuit can be used to identify what factor or factors, such as at an upstream airflow location (upstream relative to the sensor location), caused the nonzero result. One way to determine why the inverse scalar transport units are not zero includes testing how postulated errors or other conditions upstream are propagated to the location of the sensor, such as using Equation 15 and Equation 16. Temperature corrections T′ can be subject to the boundary conditions at equipment asset intakes. In an example, the temperature corrections are applied at every node to obtain a new temperature field (see Equation 17).

$$\begin{matrix}\frac{\partial }{\partial {x}_{j}} ( ρ {u}_{j} {c}_{p} {T}^{′} ) + \frac{\partial }{\partial {x}_{j}} ( k \frac{\partial {T}^{′}}{\partial {x}_{j}} ) = 0 & ( Equation 15 ) \\ {T}_{i}^{′} = \frac{1}{\dot{m} {c}_{{p}_{i}}} [ Δ {Q}^{′} - \sum {( ρ V {c}_{p} {T}^{′} )}_{o} ] & ( Equation 16 ) \\ {T}_{{i}_{new}} = {T}_{{i}_{old}} + {T}_{i}^{′} & ( Equation 17 )\end{matrix}$$

Next, updated thermal boundary conditions can be calculated and the CFD circuit 213 can update the model to obtain a new, conserved thermal field and airflow field. Subsequently, the process can include re-calculating the fictitious heat sources and heat sinks at the location of the sensors. These steps can be repeated until the fictitious heat sources and heat sinks become insignificant. In an example, the CFD model generated using the CFD circuit 213 can be considered to be valid when the model converges.

In an example, the processor circuit 210 includes a System Performance Analyzer (SPA) module that can use information from the sensor array 220, the equipment asset array 230, and the HVAC or other air-handling system 240, with data from a CFD model, to generate a system model that can be applied for (a) optimizing the energy efficiency of the system, and (b) projecting system performance under postulated scenarios.

The SPA module can use a CFD model of an environment to drive, in turn, each air-handling unit and equipment asset in the environment through its operating range. That is, the SPA module can prepare a matrix of numerical simulations, such as using the CFD circuit 213. In an example, the simulations can be used to study a sensitivity of an inlet temperature of each equipment asset (or server rack, or other specified discrete level) to a change in a performance of critical components of the HVAC or other air-handling system 240 serving the environment. Some of the parameters that can be considered by the SPA include (1) a supply temperature of each CRAC unit serving the environment, (2) a volumetric flow rate of each air mover in the environment, (3) an ON/OFF setting of each air mover in the environment, (4) a chilled water temperature or a chilled water flow rate, (5) an ambient temperature (for systems equipped with a water-side or an air-side economizer), (6) an ambient relative humidity (for systems equipped with a water-side or an air-side economizer), or (7) an equipment asset heat load.

For each change in a parameter P, the SPA module can compute and store a sensitivity coefficient for each server and server rack, such as using Equation 18.

$${S}_{ij} = \frac{\partial {T}_{i}}{\partial {P}_{j}} \approx \frac{{T}_{i} - {T}_{{i}_{b}}}{{P}_{j} - {P}_{{j}_{b}}} \qquad ( Equation 18 )$$

In Equation 18, Tᵢ is the average air temperature at the intake of the equipment asset i at the new value of parameter Pⱼ, and Tᵢ_{_{b}} and Pⱼ_{_{b}} are the corresponding baseline values (or the respective values at a previous setting). In an example, several values of each parameter can be considered because Sᵢⱼ is not expected to be constant across a range of possible values of Pⱼ.

Flow rates and other characteristics can be non-linear. For example, some equipment assets can be equipped with variable speed fans which can be configured to ramp up or ramp down depending on an intake temperature value. To accommodate such non-linear behavior, the CFD circuit 213 can model a constant temperature difference across an equipment asset, such as rather than modeling a constant air flow rate. Therefore, an intake temperature at any given equipment asset may not linearly depend on a supply temperature, such as even when recirculation or interaction with neighboring assets are eliminated (such as in environments that include leak-free cold-aisle or hot-aisle containment).

After the initial calculations, the SPA module can be configured to continuously update a CFD model sensitivity coefficient using actual historical performance information. Using actual performance information can ensure that the coefficients are accurate and reflect a present state of the modeled environment. The accuracy of the sensitivity coefficients can be critical to the predictive analysis used for planning and energy optimization. If the sensitivity coefficient is accurately known, then the impact of a change in a cooling parameter can be calculated for each equipment asset in an environment, such as using Equation 19.

ΔTᵢ=SᵢⱼΔPⱼ (Equation 19)

Using the one or more sensitivity coefficients and CFD model, a system operator can easily and quickly perform what-if analyses. The SPA module can be used to provide answers to postulated scenarios. For example, the SPA module can be used to determine the impact of installing new equipment assets, or can optionally be applied to determine where in an environment to locate a new equipment asset, such as depending on available cooling capacity and an impact on energy efficiency. The SPA module can be used to determine an impact of expected changes in outside weather conditions, such as ambient temperature and humidity. The SPA module can be used to identify a failed or failing CRAC unit, or to determine a duration between a CRAC failure event and a predicted thermal overload event for a location in the model environment or for an equipment asset in the environment. In an example, the SPA module can determine energy savings from different scenarios, such as including elevated temperature set points, installation of a variable frequency drive (VFD) unit, a shut down of one or more cooling units, or an installation of a containment system.

In an example, an SPA module can be used to explore different available options for saving energy, determining different options for mitigating cooling or power issues, and for change planning before structural changes are implemented. In an example, an output from such postulated scenarios can include using the user interface 250 to display a temperature distribution map or energy savings or losses as a result of a postulated scenario.

In an example, the processor circuit 210 can be configured to control the HVAC or other air-handling system 240 to minimize energy use with respect to cooling resources in a datacenter. Using a validated CFD model, one or more numerical “sensors” can be provided at any point in the modeled environment, such as to augment the number of physical sensors installed in the environment. Such numerical “sensors” are referred to herein as virtual sensors. A virtual sensor can be a temperature, humidity, airflow, or other environment characteristic sensor with an output that corresponds to a CFD computation result at the location of the virtual sensor in the model environment. Information from a virtual sensor can optionally be used in further CFD analysis as if the virtual sensor were a physical sensor. That is, a virtual sensor can be similarly used to generate reports, check for hot spots, or to issue alerts. In an example, information from a virtual sensor can be used for system optimization or in a feedback loop of CRAC unit control. In an example, the CFD circuit 213 can be configured to automatically generate virtual sensors at critical locations where there are no physical sensors, or a system operator can identify one or more locations of interest in a model environment for a virtual sensor to be located.

Smart zones, as described above, can be computed using the CFD circuit 213 and can use the sensitivity parameters described above. Physically, a smart zone can correspond to the areas of an environment where a given cooling resource exerts significant influence. Using a sensitivity parameter, the CFD circuit 213 can generate a contiguous subdomain of the environment, such as consisting of the finite control volumes created by the CFD mesh builder.

The CFD circuit 213 can use smart zones for predictive control, system optimization, or for updating a CFD model. In an example, updating the CFD model can include using a computational solver to implement a sub-domain solution whereby a large solution domain can be arbitrarily sub-divided into smaller subdomains and solved separately. In a real-time CFD model that executes continuously, the computational solver can update a portion of the model, such as corresponding to a smart zone, such as when a change from a previous update is a change in a particular parameter that affects the smart zone. By so limiting the function of the computational solver, a real-time model update can be performed more quickly than would be otherwise possible. For example, in an environment that includes several separate rooms, a thermal event can occur, such as a change in a setting of a CRAC unit. In this example, it may be helpful and more computationally efficient to only update the portions of the CFD model that correspond to the affected room areas, and not the entire model, such as using the above-described sub-domain technique.

In an example, a smart zone can change depending on a number of factors, such as including a performance profile of an air conditioning unit, a layout of the equipment assets in the environment, or a computational load of the equipment assets in the environment, any of which can affect power consumption and heat dissipation characteristics in a room. The CFD circuit 213 can continuously calculate and update one or more smart zones for each HVAC or other air-handling system 240 according to the conditions in the environment.

In an example, individual components of the HVAC or other air-handling system 240 can be supervised or controlled using the processor circuit 210, such as based on information from the CFD circuit 213. In an example, the processor circuit 210 can turn on or off an HVAC or other air-handling units on an as-needed basis. The processor circuit 210 can update temperature settings of in-room air conditioners, in-row coolers, or a chiller plant, such as to correspond to a prevailing cooling load. One objective for adjusting a temperature setting can include minimizing over-cooling as much as possible, such as to try to operate each component at its maximum efficiency, while avoiding hot spots at the air intakes of equipment assets in the environment. In an example, the processor circuit 210 can use information from the CFD circuit 213 to automatically adjust an air mover speed or volume characteristic to match an air volume that is calculated to be necessary to adequately cool equipment assets in the environment. In an example, turning down an air mover speed can result in energy conservation.

In an example, the processor circuit 210 can automatically update or adjust a humidity setting of an HVAC or other air-handling unit, such as to minimize expenditures of energy for humidification or dehumidification. In an example, the processor circuit 210 can coordinate HVAC or other air-handling units such that, at least within each smart zone, no two HVAC or other air-handling units are operating concurrently in competing states of humidity control, such as with one unit humidifying while the other is dehumidifying the same portion of the environment. The processor circuit 210 can be used to implement an economizer mode, such as in installations outfitted with air-side or water-side economizers, and based on outside ambient conditions. This ensures that the system takes advantage of the savings associated with “free” cooling or heating whenever possible.

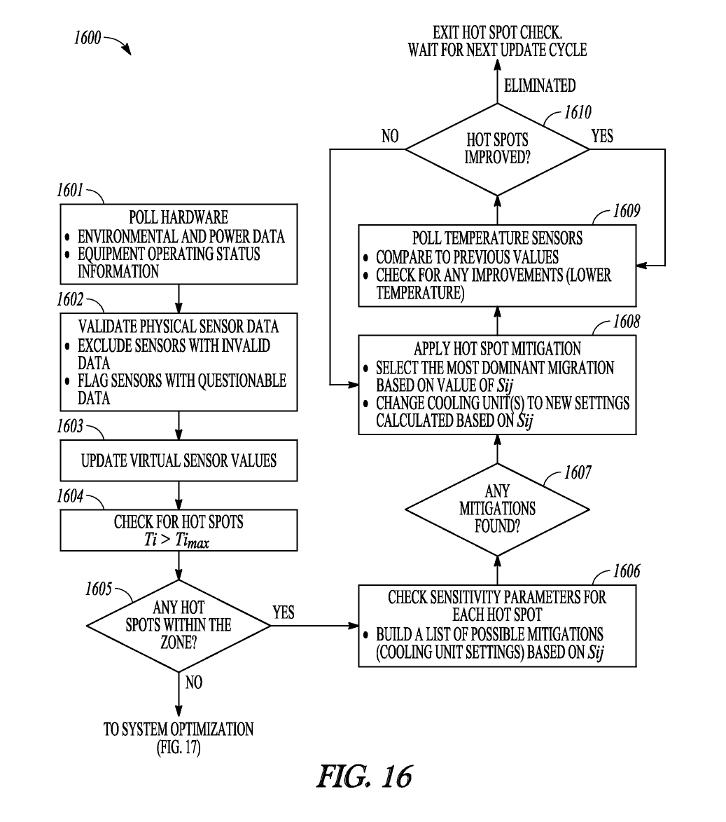

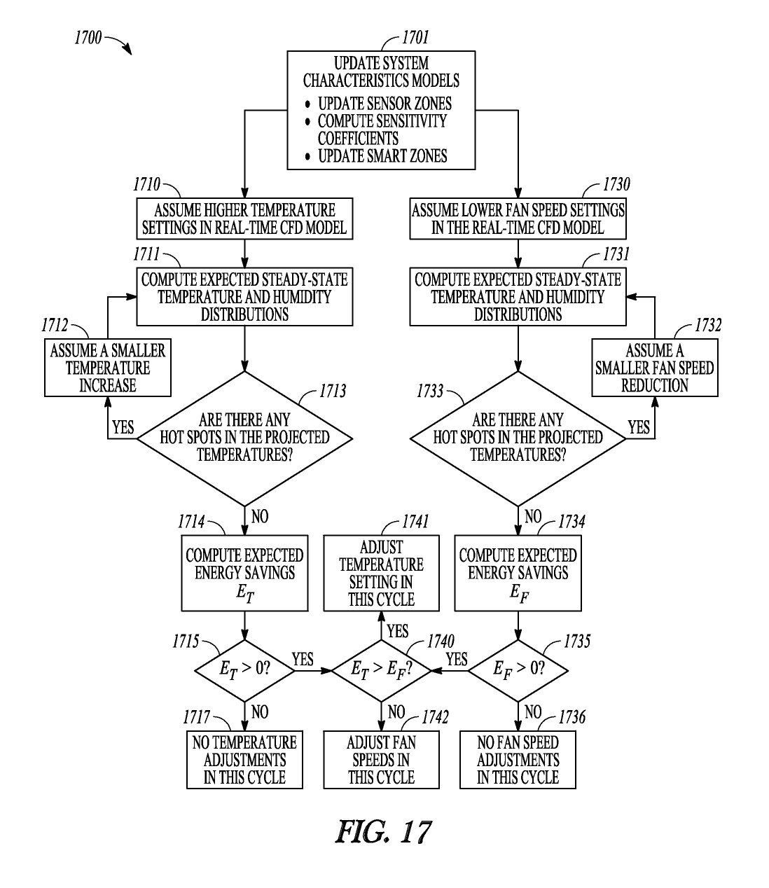

Before any of control actions are taken by the processor circuit 210, the CFD circuit 213 can perform a steady-state analysis, similar to the what-if analysis described above, to determine whether a postulated operating condition is safe or to determine whether the postulated operating condition is more energy efficient. In an example, if a smart zone is determined to be operating in a safe operating state, such as with temperature and humidity within allowable limits, optimization algorithms implemented by the CFD circuit 213 can intermittently or periodically check for avenues of energy savings within the smart zone, such as by varying one or more boundary conditions in the model, and then implementing the corresponding real-world changes corresponding to the changed boundary conditions when a more efficient model is identified. That is, the CFD circuit 213 can generate, in a virtual environment, one or more predictions using information about an entire environment or system, and characteristics from the one or more predictions can be implemented and tested in the corresponding real-world environment that the virtual environment represents (see, e.g., FIG. 17). Similarly, if a hot spot is detected in the physical environment, the CFD circuit 213 can be configured to identify an appropriate, available mitigation using the same process of what-if analysis, such as using HVAC or other air-handling units or asset parameters that affect the zone that includes the hot spot. FIG. 16 illustrates generally an example of a hot spot check method.

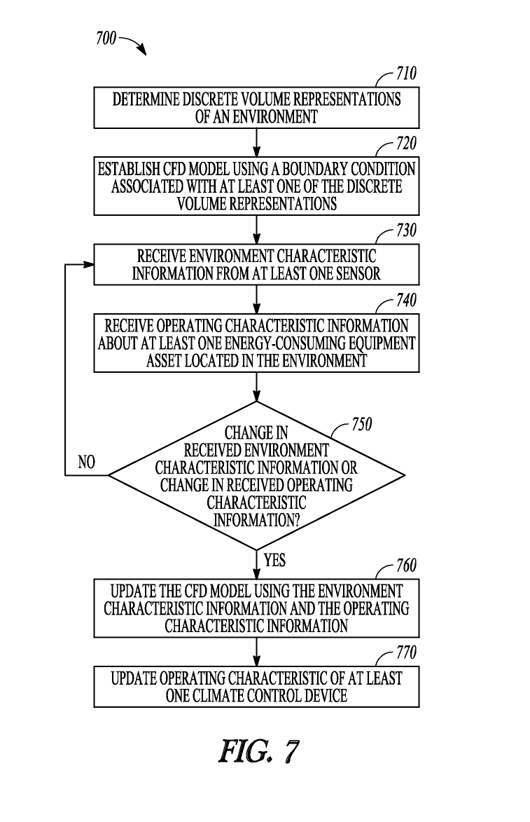

Various methods can be used to generate or use a CFD model. FIG. 7 illustrates generally an example of a first method 700 that can include generating a CFD model. At 710, the example includes determining discrete volume representations of an environment. For example, a 3D model or virtual representation of an environment can be used, and the representation can be subdivided (e.g., automatically using the CFD circuit 213) into multiple different control volumes corresponding to discrete volumes within the model, such as using the processor circuit 210.

At 720, a CFD model can be established using the CFD circuit 213. Establishing the CFD model can include using boundary conditions associated with the discrete volume representations determined at 710. In an example, the boundary conditions can be specified by a system operator, the boundary conditions can be determined experimentally, or the boundary conditions can be determined based on characteristics of equipment assets or HVAC or other air-handling units serving the environment.

At 730, the method can include receiving environment characteristic information from at least one sensor. Receiving the environment characteristic information can include receiving information about one or more of a temperature, relative humidity, airflow rate, pressure, or other characteristic of the environment. In an example, the environment characteristic information received at 730 can be received from a portion of the sensor array 220.

At 740, the method can include receiving operating characteristic information about at least one energy-consuming equipment asset located in the environment. Receiving the operating characteristic information can include, among other things, receiving information about an asset's power consumption, heat dissipation, fan speed, air filter status, or other characteristic.

At 750, the method can include determining whether a change occurred in the received environment characteristic information, or determining whether a change occurred in the received operating characteristic information. Determining a change can include monitoring information from the sensor array 220, from the equipment asset array 230, or from the HVAC or other air-handling system 240, to identify whether the information has changed by more than some specified threshold amount relative to one or more of a historic value, an average value, or a specified value. If no sufficient change is identified at 750, then the first method 700 can return to one or both of 730 and 740 to receive additional information from the at least one sensor or the at least one energy-consuming equipment asset in the environment.

If a sufficient change is identified at 750, then the first method 700 can continue at 760 with updating the CFD model using one or both of the new, or changed, environment information or operating characteristic information. At 770, the first method 700 can include updating an operating characteristic of at least one climate control device serving the environment, such as including a unit of the HVAC or other air-handling system 240. In an example, the first method 700 can additionally or alternatively include providing a recommendation to an operator, such as using the user interface 250. The recommendation can include a recommendation to change an equipment asset layout, building configuration, or other characteristic of the environment, such as to improve an energy efficiency of the system while maintaining an acceptable environment conditions for the equipment assets housed therein.

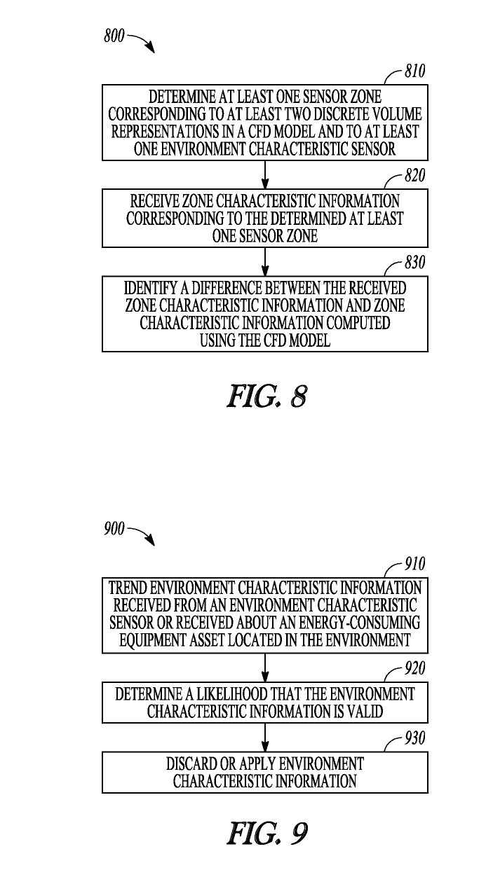

FIG. 8 illustrates generally an example of a second method 800 that can include using zone information with a CFD model. At 810, the second method 800 includes determining at least one sensor zone. A sensor zone can correspond to at least one, but often two or more, discrete volume representations in a CFD model. For example, a sensor zone can correspond to one or more of the discrete volume representations determined at 710 in the first method 700. In an example, the sensor zone determined at 810 can correspond to at least one environment characteristic sensor unit, such as can be configured to provide relative or absolute value information about the environment in which the sensor unit is located. The sensor unit can be configured to provide information about one or more of a temperature, relative humidity, pressure, airflow, or other characteristic of the environment.

At 820, the second method 800 includes receiving zone characteristic information corresponding to the determined at least one sensor zone, such as using the sensor unit referenced at 810. At 830, a difference can be identified between the received zone characteristic information (e.g., temperature, relative humidity, etc.) and zone characteristic information that is computed using a CFD model. For example, a CFD model can be used to generate a predicted or postulated value for one or more environment characteristics corresponding to a particular time and location in an environment. Information from an actual sensor unit corresponding to the location in the physical environment can be used to validate the CFD model by comparing the CFD result to the measured value. If a sufficient difference exists, then that difference can be identified at 830.

FIG. 9 illustrates generally an example of a third method 900 that can include validating information about an environment. At 910, the third method 900 includes trending at least one of measured environment characteristic information received from a sensor unit in the environment, or received information about an energy-consuming equipment asset in the environment.

In an example, trending measured environment characteristic information at 910 includes trending a series of values received over time by one or more sensor units disposed in the environment. In an example that includes a sensor unit configured to sense an environment temperature, temperature values can be received (e.g., using the processor circuit 210) periodically or intermittently over multiple minutes, hours, days, weeks, or longer intervals. The temperature value information can be trended to identify whether the temperature remains steady, such as within some well-defined bounds, or whether the temperature fluctuates, such as corresponding to time-of-day, time-of-year, processing load, or some other factor.

In an example, trending received information about an energy-consuming equipment asset in the environment at 910 includes trending a series of values received over time from at least one equipment asset. In an example, the at least one equipment asset can be configured to report information about power consumption, fan speed, processing load, or some other characteristic representative of or correlating to a heat dissipation characteristic of the asset. In an example that includes an asset configured to report information about its power consumption, the reported power consumption information can be received (e.g., using the processor circuit 210) periodically or intermittently over multiple minutes, hours, days, weeks, or longer intervals. The power consumption information can be trended to identify whether the power consumption is steady, such as within some well-defined bounds, or whether the power consumption fluctuates, such as corresponding to time-of-day, time-of-year, processing load, or some other factor.

At 920, the third method 900 includes determining a likelihood that the environment characteristic information is valid. In an example that includes characteristic temperature information received from a sensor unit, the third method 900 can include at 920 determining whether current or historic temperature information is valid, such as by determining whether the current or recent temperature information is within some specified bounds or is within some specified number of standard deviations of a running average temperature value. In an example that includes characteristic power consumption information about a particular equipment asset, the method can include at 920 determining whether current or historic power consumption information is valid, such as by determining whether the current or recent power consumption information is within some specified bounds or is within some specified number of standard deviations of a running average power consumption value. Average values or numbers of standard deviations are included as examples only. In other examples, maximum or minimum values can be used, or other statistical analyses can be applied to determine whether a present value (or a recent series of values) is reasonable in view of an expected or historic value or set of values.

At 930, the third method 900 can include discarding or applying environment characteristic information, such as based on the determined likelihood at 920. If, at 920, the environment characteristic is determined to be likely valid, then the environment characteristic information can be applied at 930, such as in updating a boundary condition or a sensitivity coefficient for a CFD model. If, at 920, the environment characteristic is determined to be likely invalid, then the environment characteristic information can be discarded at 930, or additional data can be collected before a decision to discard the information is made. For example, some characteristic information from a sensor unit or equipment asset can include anomalous data, such as due to unusual signal noise, or a brief sensor malfunction (e.g., due to maintenance during a sample event). If more data is collected, then the anomalous data (e.g., corresponding to a limited number of samples) can be discarded or averaged with other data to “smooth” the result.

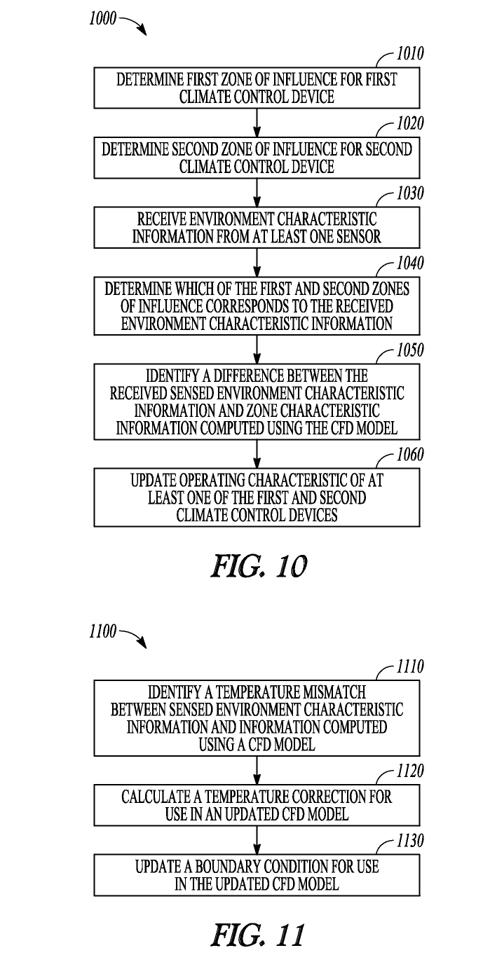

FIG. 10 illustrates generally an example of a fourth method 1000 that can include updating an operating characteristic of a climate control device based on a zone of influence. At 1010, the fourth method 1000 includes determining a first zone of influence for a first climate control device, such as a CRAC unit, and at 1020, the method includes determining a second zone of influence for a second climate control device. Determining first and second zones of influence can include, for example, identifying respective different areas in an environment that receive air from respective different first and second climate control devices. In an example, the first climate control device is a CRAC unit that controls a climate by introducing a cooled airflow to the environment. Other climate control devices can similarly be used, such as a radiant heater, vent tile, or other device.

At 1030, the fourth method 1000 includes receiving environment characteristic information from at least one sensor unit, such as indicating a change in the environment. The change can be due to, among other things, an on/off state of the first or second climate control device. At 1040, the method includes determining which of the first and second zones of influence corresponds to the received environment characteristic information received at 1030. In an example, at 1040, the method includes determining which of the first or second climate control devices exerts a greater influence on the portion of the environment that includes the sensor unit, and then assigning the sensor unit to a zone of influence corresponding to that one of the first and second climate control devices.

In an example, a CFD model can be configured to provide or predict information about a zone of, rather than a point location in, an environment. At 1050, the method includes identifying a difference between the received sensed environment characteristic information and zone characteristic information that is computed using a CFD model. At 1060, the fourth method 1000 can include updating an operating characteristic of at least one of the first and second climate control devices using information about the difference identified at 1050. For example, the information about the difference can be used as a feedback mechanism for the one of the first and second climate control devices that was determined at 1040 to correspond to the environment characteristic information received at 1030 using the at least one sensor unit.

FIG. 11 illustrates generally an example of a fifth method 1100. The fifth method 1100 includes updating a boundary condition based on a temperature calculation. For example, at 1110, the method includes identifying a temperature (or other environment characteristic) mismatch between a sensed environment characteristic value and a value that is computed using a CFD model, such as using the CFD circuit 213. At 1120, the method includes calculating a temperature correction for use in an updated CFD model. For example, at 1120, the method can include calculating an inverse scalar transport value, such as described above. At 1130, the method includes updating a boundary condition for use in the updated CFD model, such as using a result of the calculated temperature correction.

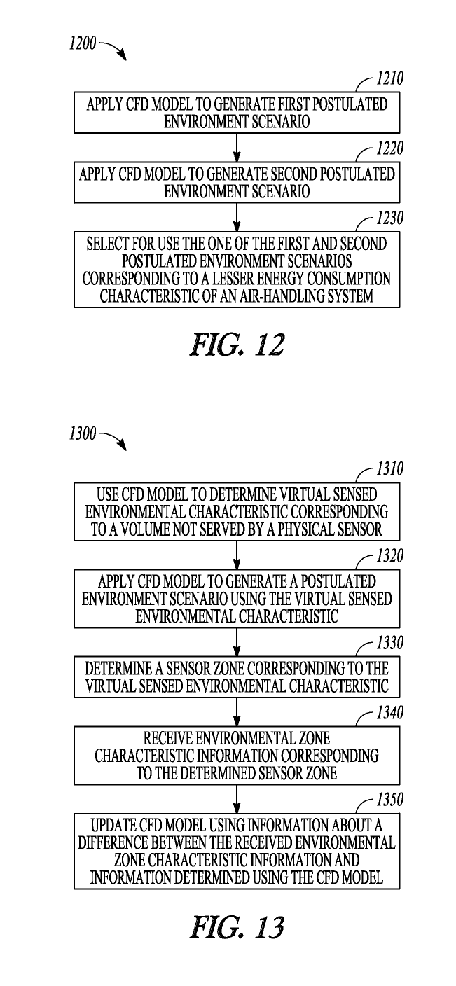

FIG. 12 illustrates generally an example of a sixth method 1200 that includes using multiple postulated environment scenarios. At 1210, the method includes applying a CFD model, such as using the CFD circuit 213, to generate a first postulated environment scenario. In an example, the first postulated environment scenario includes something other than a steady-state condition for the environment, for example, including a disaster scenario including a failure of one or more CRAC units, or including an equipment asset malfunction or equipment asset rearrangement in the same physical environment space. Other scenarios can be similarly used.

At 1220, the CFD model can be applied to generate a second postulated environment scenario. In an example, at 1210, the first postulated environment scenario includes a first proposed equipment asset arrangement, and at 1220, the second postulated scenario includes a second proposed equipment asset arrangement. At 1230, the sixth method 1200 includes selecting for use the one of the first and second postulated environment scenarios corresponding to a lesser energy consumption characteristic of an air-handling system that serves the environment. For example, a first power consumption rate of 2 MWH can correspond to the first proposed equipment asset arrangement, and a second power consumption rate of 3 MWH can correspond to the second proposed equipment asset arrangement. At 1230, the first proposed equipment asset arrangement can be selected or recommended to an operator because the first proposed equipment asset arrangement is projected or postulated to consume less energy.

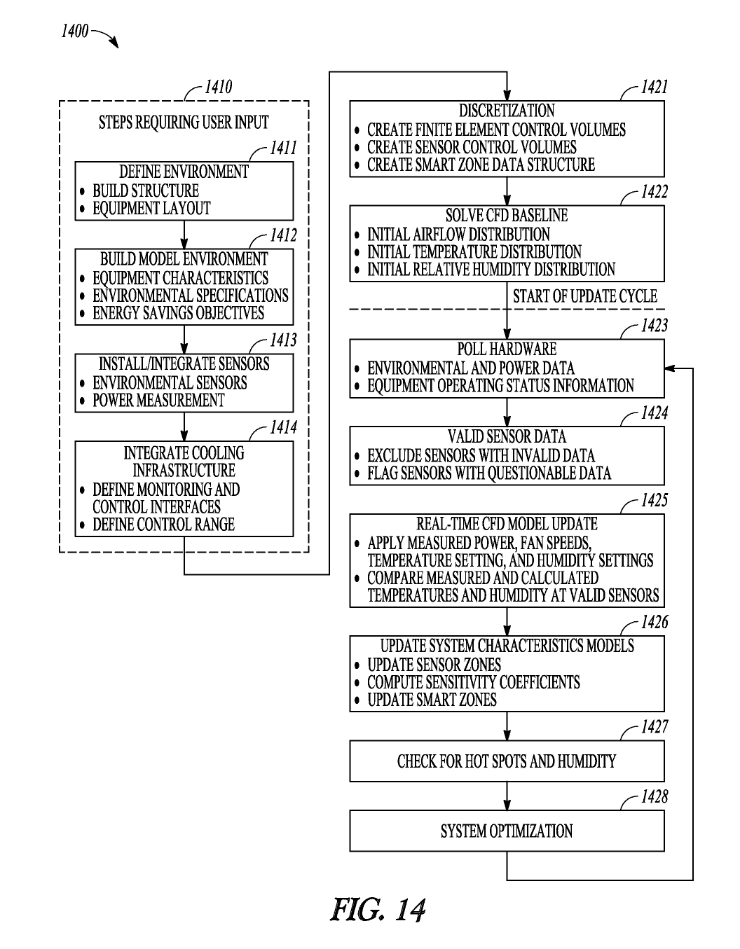

FIG. 13 illustrates generally an example of a seventh method 1300 that can include updating a CFD model. At 1310, the method includes using a CFD model to determine a virtual sensed environment characteristic at a virtual sensor location. The virtual sensed environment characteristic can correspond to a portion of a virtual environment that does not correspond to a physical sensor unit in the actual environment. Instead, the virtual sensed environment characteristic can correspond to a virtual sensor location that is location or a control volume in a discretized virtual environment.

At 1320, the method includes applying the CFD model to generate a postulated environment scenario using the virtual sensed environment characteristic. That is, the CFD model can be applied and a result of the CFD model can include an environment characteristic value corresponding to the virtual sensor location. At 1330, the method can optionally include determining a sensor zone corresponding to the virtual sensed environment characteristic and to the virtual sensor location, such as described above in the second method 800 for a physical sensor unit.

At 1340, the method can include receiving environment zone characteristic information corresponding to the sensor zone determined at 1330. That is, at 1340, the method can include receiving or calculating information about a zone characteristic using information from the virtual sensor. At 1350, a CFD model can be updated using information about a difference between the received environment zone characteristic information and other information determined using the CFD model. For example, the received environment zone characteristic information corresponding to the virtual sensor can be compared to environment zone characteristic information computed using the CFD model after one or more boundary conditions in the CFD model are updated in response to some actual change in the environment. If the comparison identifies a difference that is greater than some threshold amount, then the CFD model can be updated so that a value generated by the updated CFD model sufficiently corresponds to the virtual sensed environment characteristic value.

FIG. 14 illustrates generally an example 1400 of work flow distributions in an environment controller based on CFD, such as can be configured to use the system 200. At 1410, multiple different user inputs can be received to influence behavior of a CFD analysis. At 1411, an environment can be defined, such as in terms of a building structure or equipment asset layout. At 1412, a CFD model for the environment can be built or generated. The CFD model can be based on equipment asset characteristics, environmental specifications or targets, and energy savings objectives. At 1413, one or more sensor units can be installed or integrated with the CFD model. The one or more sensor units can comprise portions of the sensor array 220, and can include one or more of environment sensors or power measurement sensors. At 1414, the example 1400 includes integrating cooling infrastructure or hardware with the CFD circuit 213. Integrating cooling infrastructure can include defining monitoring or control interfaces, and defining a range of available controls.

The example 1400 includes a CFD workflow on the right-hand side of FIG. 14. The CFD workflow includes multiple steps, including a discretization step at 1421. In discretization, as described at length above, an environment can be computationally divided into finite control volumes. One or more of the discrete control volumes can correspond to a sensor unit, such as a physical sensor unit or a virtual sensor unit. One control volume can be used, or multiple discrete control volumes can be aggregated and used, to create one or more smart zones in the discrete space.

At 1422, the CFD workflow includes solving a baseline or reference CFD model. The baseline CFD model can be based on, among other factors, an initial airflow distribution in the environment, an initial temperature distribution in the environment, or an initial relative humidity distribution in the environment. At 1423, the CFD workflow includes polling various hardware corresponding to the model environment. Environment characteristic and power information can be received from dedicated sensor units or from equipment assets that can be configured to self-report.

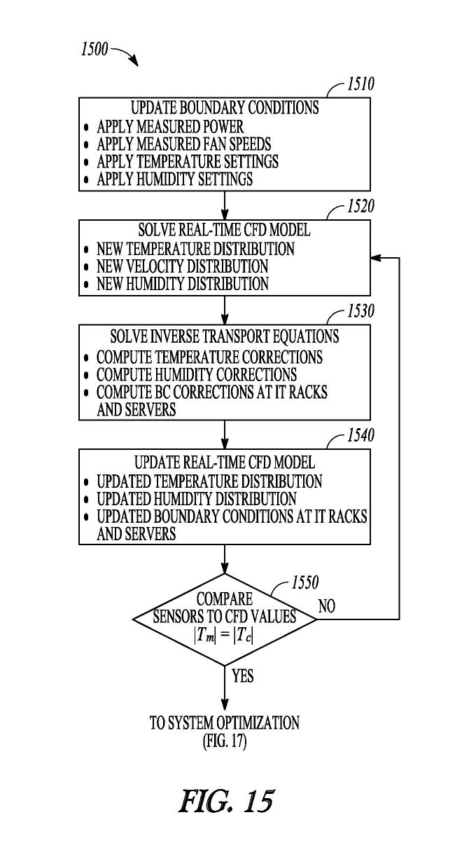

At 1424, the information received at 1423 from the hardware polling can be validated. Environment characteristic or power information that is invalid can be excluded from subsequent CFD analyses, or sensor units or equipment assets reporting questionable or borderline data can be flagged for operator review. At 1425, the CFD workflow includes computing a substantially real-time CFD model update (see, e.g., FIG. 15). The model update can be computed using, among other things, measured power, temperature, airflow, or other environment characteristic information. In an example, computing the model update can include comparing measured and calculated environment condition values. If the measured and calculated environment condition values do not sufficiently correspond, then at 1426 the CFD workflow can include updating system characteristics models. Updating characteristics models can include, among other things, updating sensor zones. If the measured and calculated environment condition values do not sufficiently correspond, then at 1426 the CFD workflow can include updating system characteristics models. Updating characteristics models can include, among other things, updating one or more sensor zones to change a portion of the environment that is considered to be monitored by a particular sensor unit. Updating characteristics models can include computing sensitivity coefficients for sensor units or equipment assets, or can include updating one or more smart zones. At 1427, the CFD workflow includes checking for hot spots or other out-of-bounds environment conditions, and at 1428, the CFD workflow includes system optimization, such as including checking whether any opportunities exist for energy savings, such as by reducing an operating power of a CRAC unit without detriment to equipment assets in the environment.

FIG. 15 illustrates generally an example 1500 that can include using the CFD circuit 213 to perform a CFD model update, such as substantially in real-time. At 1510, the method includes updating one or more boundary conditions for use in a CFD model. Updating a boundary condition can include using measured, detected, or received power information from the equipment asset array 230. Updating a boundary condition can include using measured fan speed information, such as including information from fans in the equipment asset array 230, or information from fans in one or more units of the HVAC or other air-handling system 240. Updating a boundary condition can include receiving one or more of temperature or humidity settings, such as from a system operator.

At 1520, the method can include solving the CFD model, substantially in real-time, using the boundary condition information from 1510. Solving the CFD model can include providing one or more of an updated temperature distribution, an updated airflow velocity distribution, or an updated humidity distribution in the model environment.

At 1530, the method can include solving one or more inverse transport equations. Using the inverse transport equations, temperature or humidity corrections can be computed. Boundary condition corrections can be computed, such as at discrete sensors or at discrete assets in the equipment asset array 230.

At 1540, the method can include updating a CFD model substantially in real time. Updating the model can include using the updated temperature, humidity, or boundary condition information, such as resulting from the inverse transport equations solved at 1530.

At 1550, one or more measured environment variable values, such as received from the sensor array 220, can be compared to values computed using the updated CFD model. If the values sufficiently correspond, then the method 1500 can continue at FIG. 17 with one or more system optimization activities. If the values do not sufficiently correspond, then the method 1500 can return to 1520 where the CFD model can be solved using the new measured environment variable values.

FIG. 16 illustrates generally an example of a method 1600 that can be implemented using the processor circuit 210 to identify hot spots, such as in one or more smart zones. At 1601, the method includes polling hardware in the model environment. Polling hardware can include, for example, receiving environment variable values, power consumption information, or equipment asset operating status information. In an example, the hardware polling includes receiving information from one or more units in the sensor array 220, in the equipment asset array 230, or in the HVAC or other air-handling system 240.

At 1602, the method 1600 can include validating physical sensor data. Validating sensor data is described above in the discussion of FIG. 9. In an example, as a result of the sensor validation step, the method 1602 can include excluding from analysis any data from sensor units with invalid data, or flagging data from sensor units with questionable or borderline data.

At 1603, any virtual sensor values can be updated. Updating a virtual sensor value can include using a CFD model to predict or calculate an environment variable value at a specified location in the CFD mesh.

At 1604, the method 1600 includes checking for hot spots. At any point or location in the model for which there is temperature information, the temperature information can be checked against a specified maximum (or minimum) temperature value. For example, where a sensor unit or a virtual sensor corresponds to an equipment asset exhaust, information about a temperature at the exhaust can be compared to a specified maximum temperature for that exhaust location. The information about the temperature can be received from the same sensor unit corresponding to the equipment asset exhaust or can be a value calculated using a virtual sensor. At 1605, the method 1600 includes determining whether any hot spots are present within the zone corresponding to the location checked at 1604. If there are no hot spots detected, then the method can process with one or more system optimization activities, such as described at FIG. 17. If a hot spot is detected, then the method continues at 1606.

At 1606, sensitivity parameters, if any, can be checked for each hot spot identified at 1604. The processor circuit 210 can build a list of possible mitigation scenarios based on the sensitivity parameters. In an example, at 1607, if a location corresponding to a hot spot is determined to have a high sensitivity to a particular available cooling unit, then the settings of the particular available cooling unit can be tuned or adjusted at 1608 to mitigate the hot spot, such as by increasing a air volume flow rate or decreasing a temperature of air from the particular unit. If multiple HVAC or other air-handling units are available, then the respective sensitivity parameters for the units can be compared, and the unit with the greatest sensitivity can be selected for mitigating use.

At 1609, the method 1600 can include polling one or more sensor units (or using one or more virtual sensors). Temperature (or other environment characteristic information) values can be received from the polled sensor units and the values can be compared to previous values that indicated the hot spot. At 1610, if the hot spot is improved, but not eliminated, then the method can continue at 1609 with continuing to poll the sensor units until the hot spot is eliminated. At 1610, if the hot spot is eliminated, then the method can exit the hot spot check method. At 1610, if the hot spot is not improved, then the method 1600 can return to 1608 and a different hot spot mitigation technique can be implemented. For example, a supplemental or alternative unit in the HVAC or other air-handling system 240 can be selected for use, or a parameter of a unit already in use can be updated or adjusted.

FIG. 17 illustrates generally an example 1700 that includes optimizing a cooling infrastructure using CFD analyses. At 1701, the method 1700 includes updating one or more models (e.g., CFD models) that characterize a system. The method at 1701 can include updating one or more sensor zones, computing one or more sensitivity coefficients for one or more units in the HVAC or other air-handling system 240, or updating smart zones, such as by reconfiguring boundaries of existing smart zones or identifying one or more new smart zones.

A system optimization method can proceed by postulating one or more available energy-reducing, adverse event, or other scenarios. For example, a system optimization method can proceed by assuming elevated or reduced temperatures in the model environment, assuming an HVAC or other air-handling unit failure, or assuming different fan speed settings, among other events or variable states. The example method 1700 of FIG. 17 refers to two of the many possible assumptions, particularly an over-temperature (1710) and an under-speed fan (1730).

At 1710, the method can include using the CFD circuit 213 to assume a higher temperature setting in a CFD model. At 1711, the method includes computing an expected steady-state temperature and/or humidity distribution based on the assumptions at 1710. At 1713, the method can check whether there are any hot spots in the projected model. If there are hot spots, then the method can continue at 1712 by assuming a smaller temperature increase than was used originally at 1710, and then returning to 1711 to re-compute one or more of the expected steady-state temperature or humidity values. If there are no hot spots at 1713, then the method can continue at 1714 with computing an expected energy savings E_{T}.

At 1715, the method includes determining whether there is a sufficiently significant energy savings E_{T} due to the change in temperature, or if the energy savings E_{T} is not greater than zero. If there is not a sufficiently significant energy savings E_{T}, or if the energy savings E_{T} is not greater than zero, then at 1717 no temperature adjustments are made in the current computational cycle. If, at 1715, the energy savings E_{T} is sufficiently significant or greater than zero, then the energy savings E_{T} can be compared to a energy savings E_{F} due to a fan speed change at 1740. If the energy savings E_{T} is greater than the energy savings E_{F} due to the fan speed change, then at 1741 a temperature setting of a unit in the HVAC or other air-handling system 240 can be adjusted in the current cycle. If the energy savings E_{T} is less than the energy savings E_{F} due to the fan speed change, then at 1742 a fan speed of the unit in the HVAC or other air-handling system 240 can be adjusted in the current cycle.

At 1730, the method can include using the CFD circuit 213 to assume a lower fan speed setting in a CFD model. At 1731, the method includes computing an expected steady-state temperature and/or humidity distribution based on the assumptions at 1730. At 1733, the method can check whether there are any hot spots in the projected model. If there are hot spots, then the method can continue at 1732 by assuming a smaller temperature increase than was used originally at 1730, and then returning to 1731 to re-compute one or more of the expected steady-state temperature or humidity values. If there are no hot spots at 1733, then the method can continue at 1734 with computing an expected energy savings E_{F} due to the fan speed change.

At 1735, the method includes determining whether there is a sufficiently significant energy savings E_{F} due to the fan speed change, or if the energy savings E_{F} is not greater than zero. If there is not a sufficiently significant energy savings E_{F}, or if the energy savings E_{F} is not greater than zero, then at 1736 no fan speed adjustments are made in the current computational cycle. If, at 1735, the energy savings E_{F} due to the fan speed change is sufficiently significant or greater than zero, then the energy savings E_{F} can be compared to the energy savings E_{T} due to the change in temperature at 1740. If the energy savings E_{T} due to the change in temperature is greater than the energy savings E_{F} due to the fan speed change, then at 1741 a temperature setting of a unit in the HVAC or other air-handling system 240 can be adjusted in the current cycle. If the energy savings E_{T} is less than the energy savings E_{F} due to the fan speed change, then at 1742 a fan speed of the unit in the HVAC or other air-handling system 240 can be adjusted in the current cycle.

### VARIOUS NOTES & EXAMPLES

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A device-assisted method for generating a computational fluid dynamics (CFD) model for an enclosed environment to be served by a heating, ventilation, air-conditioning (HVAC), or other air-handling system, the method comprising:
determining multiple discrete volume representations of corresponding discrete volumes of the enclosed environment;
establishing a CFD model, using a processor circuit, using a system of energy, enthalpy or fluid flow constraints and information about a boundary condition associated with at least one of the discrete volume representations;
receiving sensed environment characteristic information from at least one environment characteristic sensor configured to provide the sensed environment characteristic information about the enclosed environment;
receiving operating characteristic information about at least one energy-consuming equipment asset located in the enclosed environment; and
updating the CFD model using the received sensor information and the received operating characteristic information.

2. The method of claim 1, wherein the updating the CFD model includes in response to identifying a difference between the received sensed environment characteristic information and corresponding information determined using the CFD model.

3. The method of claim 2, comprising:
determining, using the processor circuit, at least one sensor zone corresponding to at least two of the discrete volume representations and corresponding to the at least one environment characteristic sensor; and
wherein the receiving the sensed environment characteristic information from the at least one environment characteristic sensor includes receiving environment zone characteristic information corresponding to the determined at least one sensor zone; and
wherein the identifying the difference between the received sensed environment characteristic information and the corresponding information determined using the CFD model includes identifying a difference between the received environment zone characteristic information and the corresponding information determined using the CFD model.

4. The method of claim 3, wherein the determining the at least one sensor zone includes identifying a region in a datacenter environment that corresponds to two or more of the multiple discrete volume representations, the two or more of the multiple discrete volume representations having a substantially similar environment characteristic, the environment characteristic including one of a temperature, pressure, particulate content, or moisture characteristic.

5. The method of claim 1, comprising:
determining, for first and second climate control devices, corresponding first and second zones of influence of the devices, the first and second zones of influence corresponding to different volumes of the enclosed environment;
determining which one of the first and the second zones of influence corresponds to the received sensed environment characteristic information;
identifying a difference between the received sensed environment characteristic information and corresponding information determined using the CFD model; and
updating an operating characteristic of one of the first and second climate control devices corresponding to the determined one of the first and second zones of influence, to change the ambient environment characteristic in the determined one of the first and second zones of influence.

6. The method of claim 1, wherein the receiving the operating characteristic information about the at least one energy-consuming equipment asset located in the enclosed environment includes identifying an updated boundary condition at one or more of the multiple discrete volume representations, and wherein the updating the CFD model includes using the updated boundary condition.

7. The method of claim 1, comprising validating the received sensed environment characteristic information from the at least one environment characteristic sensor, the validating including determining a likelihood that the received sensed environment characteristic information is valid based on a historical trend of information received from the same environment characteristic sensor.

8. The method of claim 1, wherein the receiving the operating characteristic information about the at least one energy-consuming equipment asset located in the enclosed environment includes receiving information about at least one of a power consumption, heat dissipation, temperature, on/off status, or fan speed characteristic of the equipment asset, and wherein the updating the CFD model includes using an updated boundary condition that is based on the received information about the at least one of the power consumption, heat dissipation, temperature, on/off status, or fan speed characteristic of the equipment asset.

9. The method of claim 1, wherein the updating the CFD model using the received sensor information and the received operating characteristic information includes:
identifying a temperature mismatch between the sensed environment characteristic information from the at least one environment characteristic sensor and corresponding information determined using the CFD model;
calculating a temperature correction for use in the updated CFD model, the temperature correction calculated using the CFD model, applied with reversed airflow characteristics, and using the identified temperature mismatch; and
updating a boundary condition for use in updating the CFD model using the calculated temperature correction.

10. The method of claim 1, including applying the updated CFD model, using the processor circuit, to generate first and second postulated environment scenarios, each scenario corresponding to a different operating characteristic of the HVAC or other air-handling system serving the enclosed environment; and
selecting, for implementation by the HVAC or other air-handling system serving the enclosed environment, the operating characteristic of the HVAC or other air-handling system serving the enclosed environment that corresponds to the one of the first and second postulated environment scenarios that indicates a lesser energy consumption characteristic of the HVAC or other air-handling system.

11. The method of claim 1, including applying the updated CFD model, using the processor circuit, to generate first and second postulated environment scenarios, each scenario corresponding to a different operating characteristic of the at least one energy-consuming equipment asset located in the enclosed environment; and
selecting, for implementation by the HVAC or other air-handling system serving the enclosed environment, the operating characteristic of the at least one energy-consuming equipment asset that corresponds to the one of the first and second postulated environment scenarios that indicates a lesser energy consumption characteristic of the HVAC or other air-handling system.

12. The method of claim 1, comprising:
determining a virtual sensed environment characteristic using the CFD model, the virtual sensed environment characteristic corresponding to a discrete volume of the enclosed environment that is not served by a physical environment characteristic sensor; and
applying the updated CFD model to generate a postulated environment scenario using information about the virtual sensed environment characteristic.

13. The method of claim 12, comprising:
determining, using the processor circuit, at least one sensor zone corresponding to the virtual sensed environment characteristic; and
wherein the receiving the sensed environment characteristic information from the at least one environment characteristic sensor includes receiving environment zone characteristic information corresponding to the determined at least one sensor zone; and
updating the CFD model, including using information about a difference between the received sensed environment characteristic information and corresponding information determined using the CFD model including identifying a difference between the received environment zone characteristic information and the corresponding information determined using the CFD model.

14. A system for controlling a climate in a datacenter environment using a heating, ventilation, air-conditioning (HVAC), or other air-handling system, the system comprising:
a user interface device comprising a display and a processor circuit, the display and the processor circuit configured to provide, to a user, an interactive three-dimensional virtual model of the datacenter environment;
a data input circuit coupled to the processor circuit, the data input circuit configured to receive information about (1) an environment characteristic about the datacenter environment, from an environment characteristic sensor located in the datacenter environment, and (2) an operating characteristic of at least one energy-consuming equipment asset located in the datacenter environment; and
a computational fluid dynamics (CFD) model processing circuit, wherein the CFD model processing circuit is configured to generate a real-time CFD model using a system of constraints and boundary conditions associated with discrete volume representations of the datacenter environment, and wherein the CFD model processing circuit is configured to update the CFD model using the received information from the data input circuit about the sensed environment characteristic and the operating characteristic of the at least one energy-consuming equipment asset located in the datacenter environment.

15. The system of claim 14, wherein the CFD model processing circuit is configured to use information about a virtual sensor to update the CFD model, the virtual sensor determined using postulated information from the real-time CFD model about an environment characteristic of a discrete volume of the datacenter environment.

16. The system of claim 14, wherein the CFD model processing circuit is configured to generate a postulated CFD model for the datacenter environment based on a theoretical change in at least one of the HVAC or other air-handling system serving the datacenter environment, or the at least one energy-consuming equipment asset located in the datacenter environment.

17. The system of claim 14, comprising a sensor data verification circuit, including a memory circuit, wherein the sensor data verification circuit is configured to provide a likelihood that the sensed environment characteristic is accurate, the likelihood based on previously-acquired information, stored in the memory circuit, from the same environment characteristic sensor.

18. A device-assisted method for generating a computational fluid dynamics (CFD) model for a datacenter environment to be served by a heating, ventilation, air-conditioning (HVAC), or other air-handling system, the method comprising:
establishing a CFD model, using a processor circuit, using a system of constraints and boundary conditions associated with multiple discrete volume representations corresponding to discrete volumes of the datacenter environment;
generating a first postulated CFD model, using the processor circuit, based on the CFD model and on a user-input theoretical change in the HVAC or other air-handling system serving the datacenter environment;
evaluating an energy consumption characteristic of the HVAC or other air-handling system serving the datacenter environment according to each of the and the first postulated CFD models; and
displaying, to a user of the device, an indication of the energy consumption characteristics of the HVAC or other air-handling system according to each of the and the first postulated CFD models.

19. The method of claim 18, comprising:
serving the datacenter environment using the HVAC or other air-handling system according to a first system configuration;
identifying an unavailability of a portion of the HVAC or other air-handling system that is intended to be used in the first system configuration;
identifying an alternative system configuration for the HVAC or other air-handling system for serving the datacenter environment, the alternative system configuration excluding the unavailable portion of the HVAC or other air-handling system, and the alternative system configuration based on the generated first postulated CFD model.

20. The method of claim 18, wherein at least one of the establishing the CFD model or the generating the first postulated CFD model includes using received operating characteristic information about at least one energy-consuming equipment asset located in the datacenter environment.
